(19) United States
(12) Patent Application Publication
(10) Pub. No.: US 2018/0031807 A1
(43) Pub. Date: Feb. 1, 2018

(54) OPTICAL IMAGING LENS ASSEMBLY, IMAGE CAPTURING APPARATUS AND ELECTRONIC DEVICE

(71) Applicant: LARGAN PRECISION CO., LTD., Taichung City (TW)

(72) Inventors: Chun-Yen Chen, Taichung City (TW); Shu-Yun Yang, Taichung City (TW)

(21) Appl. No.: 15/421,318

(22) Filed: Jan. 31, 2017

(30) Foreign Application Priority Data
Jul. 28, 2016 (TW) 105123926

(51) Int. Cl. G02B 13/00; G02B 9/64

(52) U.S. Cl. CPC G02B 13/0045; G02B 9/64

(57) ABSTRACT

An optical imaging lens assembly includes, in order from an object side to an image side, a first lens element, a second lens element, a third lens element, a fourth lens element, a fifth lens element, a sixth lens element and a seventh lens element. The first lens element has negative refractive power. The second lens element has negative refractive power. The third lens element has positive refractive power. The fourth lens element has positive refractive power. The fifth lens element has negative refractive power. The seventh lens element has an object-side surface and an image-side surface being both aspheric, wherein at least one of the object-side surface and the image-side surface of the seventh lens element includes at least one inflection point.

### RELATED APPLICATIONS

This application claims priority to Taiwan Application Serial Number 105123926, filed Jul. 28, 2016, which is herein incorporated by reference.

### BACKGROUND

Technical Field

The present disclosure relates to an optical imaging lens assembly and an image capturing apparatus. More particularly, the present disclosure relates to a compact optical imaging lens assembly with large field of view and an image capturing apparatus which are applicable to electronic devices.

Description of Related Art

In recent years, with the popularity of mobile terminals having camera functionalities, the demand of miniaturized optical systems has been increasing. The sensor of a conventional optical system is typically a CCD (Charge-Coupled Device) or a CMOS (Complementary

Metal-Oxide-Semiconductor) sensor. As the advanced semiconductor manufacturing technologies have allowed the pixel size of sensors to be reduced and compact optical systems have gradually evolved toward the field of higher megapixels, there is an increasing demand for compact optical systems featuring better image quality.

With trends of multiple applications of optical imaging lens assemblies and rapid developments of related products, optical imaging lens assemblies are not only required to be featured with compact size and high image quality, the specifications of optical imaging lens assemblies have become more demanding as well. Furthermore, in order to achieve a wider photographing range and work effectively in various environments, optical imaging lens assemblies are required to enlarge the field of view and have properties of resistance to temperature changes. Hence, an optical imaging lens assembly simultaneously equipped with the features of large field of view, compact size, resistance to environmental changes and high image quality could satisfy the specifications and requirements in the future markets, so as to be applied to electronic devices such as extreme sports cameras, driving recorders, rear view camera systems, intelligent electronic devices, head-mounted displays, network monitoring devices, portable electronic devices, unmanned aerial vehicles and is so on.

However, the conventional optical imaging lens assemblies with large field of view cannot meet the requirements as previously mentioned, so there is an urgent need in developing a wide-angle optical imaging lens assembly with the features of large field of view, compact size, resistance to environmental changes and high image quality.

### SUMMARY

According to one aspect of the present disclosure, an optical imaging lens assembly includes, in order from an object side to an image side, a first lens element, a second lens element, a third lens element, a fourth lens element, a fifth lens element, a sixth lens element and a seventh lens element. The first lens element has negative refractive power. The second lens element has negative refractive power. The third lens element has positive refractive power. The fourth lens element has positive refractive power. The fifth lens element has negative refractive power. The seventh lens element has an object-side surface and an image-side surface being both aspheric, wherein at least one of the object-side surface and the image-side surface of the seventh lens element includes at least one inflection point. The optical imaging lens assembly has a total of seven lens elements. When a focal length of the optical imaging lens assembly is f, an axial distance between the sixth lens element and the seventh lens element is T67, a central thickness of the third lens element is CT3, and a central thickness of the sixth lens element is CT6, the following conditions are satisfied:

0<f/T67<9.0; and

0.05<CT6/CT3<0.85.

According to another aspect of the present disclosure, an image capturing apparatus includes the optical imaging lens assembly according to the aforementioned aspect and an image sensor, wherein the image sensor is disposed on an image surface of the optical imaging lens assembly.

According to still another aspect of the present disclosure, an electronic device includes the image capturing apparatus according to the foregoing aspect.

According to yet another aspect of the present disclosure, an optical imaging lens assembly includes, in order from an object side to an image side, a first lens element, a second lens element, a third lens element, a fourth lens element, a fifth lens element, a sixth lens element and a seventh lens element. The first lens element has negative refractive power. The second lens element has negative refractive power. The third lens element has positive refractive power. The fourth lens element has positive refractive power. The fifth lens element with negative refractive power has an image-side surface being concave in a paraxial region thereof. The seventh lens element has an object-side surface and an image-side surface being both aspheric, wherein at least one of the object-side surface and the image-side surface of the seventh lens element includes at least one inflection point. The optical imaging lens assembly has a total of seven lens elements. When a focal length of the optical imaging lens assembly is f, an axial distance between the sixth lens element and the seventh lens element is T67, a curvature radius of an object-side surface of the fifth lens element is R9, and a curvature radius of the image-side surface of the fifth lens element is R10, the following conditions are satisfied:

0<f/T67<9.0; and

−0.20<(R9+R10)/(R9−R10)<2.40.

### BRIEF DESCRIPTION OF THE DRAWINGS

FIG. 1 is a schematic view of an image capturing apparatus according to the 1st embodiment of the present disclosure;

FIG. 2 shows spherical aberration curves, astigmatic field curves and a distortion curve of the image capturing apparatus according to the 1st embodiment;

FIG. 3 is a schematic view of an image capturing apparatus according to the 2nd embodiment of the present disclosure;

FIG. 4 shows spherical aberration curves, astigmatic field curves and a distortion curve of the image capturing apparatus according to the 2nd embodiment;

FIG. 5 is a schematic view of an image capturing apparatus according to the 3rd embodiment of the present disclosure;

FIG. 6 shows spherical aberration curves, astigmatic field curves and a distortion curve of the image capturing apparatus according to the 3rd embodiment;

FIG. 7 is a schematic view of an image capturing apparatus according to the 4th embodiment of the present disclosure;

FIG. 8 shows spherical aberration curves, astigmatic field curves and a distortion curve of the image capturing apparatus according to the 4th embodiment;

FIG. 9 is a schematic view of an image capturing apparatus according to the 5th embodiment of the present disclosure;

FIG. 10 shows spherical aberration curves, astigmatic field curves and a distortion curve of the image capturing apparatus according to the 5th embodiment;

FIG. 11 is a schematic view of an image capturing apparatus according to the 6th embodiment of the present disclosure;

FIG. 12 shows spherical aberration curves, astigmatic field curves and a distortion curve of the image capturing apparatus according to the 6th embodiment;

FIG. 13 is a schematic view of an image capturing apparatus according to the 7th embodiment of the present disclosure;

FIG. 14 shows spherical aberration curves, astigmatic field curves and a distortion curve of the image capturing apparatus according to the 7th embodiment;

FIG. 15 is a schematic view of an image capturing apparatus according to the 8th embodiment of the present disclosure;

FIG. 16 shows spherical aberration curves, astigmatic field curves and a distortion curve of the image capturing apparatus according to the 8th embodiment;

FIG. 17 is a schematic view of an image capturing apparatus according to the 9th embodiment of the present disclosure;

FIG. 18 shows spherical aberration curves, astigmatic field curves and a distortion curve of the image capturing apparatus according to the 9th is embodiment;

FIG. 19 is a schematic view of an image capturing apparatus according to the 10th embodiment of the present disclosure;

FIG. 20 shows spherical aberration curves, astigmatic field curves and a distortion curve of the image capturing apparatus according to the 10th embodiment;

FIG. 21 is a schematic view of an image capturing apparatus according to the 11th embodiment of the present disclosure;

FIG. 22 shows spherical aberration curves, astigmatic field curves and a distortion curve of the image capturing apparatus according to the 11th embodiment;

FIG. 23 is a schematic view of an image capturing apparatus according to the 12th embodiment of the present disclosure;

FIG. 24 shows spherical aberration curves, astigmatic field curves and a distortion curve of the image capturing apparatus according to the 12th embodiment;

FIG. 25 shows a schematic view of the parameter Yc71 of the optical imaging lens assembly of the image capturing apparatus according to FIG. 1;

FIG. 26 shows a schematic view of the parameter Yc72 of the optical imaging lens assembly of the image capturing apparatus according to FIG. 1;

FIG. 27 shows a schematic view of the parameter Y11 of the optical imaging lens assembly of the image capturing apparatus according to FIG. 1;

FIG. 28 shows a schematic view of the parameter Y72 of the optical imaging lens assembly of the image capturing apparatus according to FIG. 1;

FIG. 29 shows an electronic device according to the 13th embodiment of is the present disclosure;

FIG. 30 shows an electronic device according to the 14th embodiment of the present disclosure; and

FIG. 31 shows an electronic device according to the 15th embodiment of the present disclosure.

### DETAILED DESCRIPTION

An optical imaging lens assembly includes, in order from an object side to an image side, a first lens element, a second lens element, a third lens element, a fourth lens element, a fifth lens element, a sixth lens element and a seventh lens element. The optical imaging lens assembly has a total of seven lens elements.

According to the optical imaging lens assembly of the present disclosure, there can be an air gap between every two of the first lens element, the second lens element, the third lens element, the fourth lens element, the fifth lens element, the sixth lens element and the seventh lens element that are adjacent to each other, that is, each of the first through seventh lens elements of the optical imaging lens assembly is a single and non-cemented lens element. As a result of the manufacturing process of the cemented lenses being more complex than the non-cemented lenses, in particular, cemented surfaces of lens elements need to have accurate curvature to ensure two lens elements will be highly cemented. However, during the cementing process, those two lens elements might not be highly cemented due to displacement and it is thereby not favorable for the image quality of the optical imaging lens assembly. Therefore, there can be an air gap between every two of the first lens element, the second lens element, the third lens element, the fourth lens element, the fifth lens element, the sixth lens element and the seventh lens element that are adjacent to each other in the present disclosure for avoiding the problem generated by the cemented lens elements.

The first lens element has negative refractive power. Therefore, it is favorable for forming a retro-focus lens structure, so that the light of large field of view can be incident into the optical imaging lens assembly.

The second lens element has negative refractive power, and can have an object-side surface being convex in a paraxial region thereof and an image-side surface being concave in a paraxial region thereof. Therefore, it is favorable for negative refractive power of the first lens element to be shared so as to guide the light of large field of view being incident on the first lens element further into the optical imaging lens assembly and agree with the features of a retro-focus lens structure, thus the light of large field of view can be easier to propagate into the optical imaging lens assembly.

The third lens element has positive refractive power. Therefore, it is favorable for balancing negative refractive power of the lens elements of the object side and effectively reducing aberrations caused by the light of large field of view.

The fourth lens element has positive refractive power. Therefore, it is favorable for converging the light into the optical imaging lens assembly so as to reduce the total track length thereof.

The fifth lens element has negative refractive power, and can have an image-side surface being concave in a paraxial region thereof. Therefore, it is favorable for balancing positive refractive power of the fourth lens element so as to correct the chromatic aberration, enhance negative refractive power of the fifth lens element and reduce the lateral chromatic aberration of the optical imaging lens assembly.

The seventh lens element can have art object-side surface being convex in a paraxial region thereof and an image-side surface being concave in a paraxial region thereof. Furthermore, the object-side surface of the seventh lens element can include at least one concave shape in an off-axial region thereof. At least one of the object-side surface and the image-side surface of the seventh lens element includes at least one inflection point. Therefore, it is favorable for effectively correcting off-axial aberrations of the optical imaging lens assembly, reducing the photosensitivity, improving the image quality, controlling the back focal length and preventing the total track length from being too long.

When a focal length of the optical imaging lens assembly is f, and an axial distance between the sixth lens element and the seventh lens element is T67, the following condition is satisfied: 0<f/T67<9.0. Therefore, it is favorable for maintaining the short focal length of the optical imaging lens assembly with large field of view, and properly adjusting the axial distance between the sixth lens element and the seventh lens element, so as to be beneficial to the assembling of the optical imaging lens assembly. More preferably, the following condition is satisfied: 0<f/T67<5.0.

When a central thickness of the third lens element is CT3, and a central thickness of the sixth lens element is CT6, the following condition is satisfied: 0.05<CT6/CT3<0.85. Therefore, it is favorable for adjusting a central thickness proportion of the third lens element to the sixth lens element so as to reduce influence on image quality caused by unbalanced spatial configuration of the lens elements. More preferably, the following condition is satisfied: 0.05<CT6/CT3<0.55.

When a curvature radius of an object-side surface of the fifth lens element is R9, and a curvature radius of the image-side surface of the fifth lens element is R10, the following condition is satisfied: −2.40<(R9+R10)/(R9−R10)<2.40. Therefore, it is favorable for molding and effectively controlling the surface shape of the fifth lens element, so that molding errors and stress resulted from excessive surface curvature of the fifth lens element can be avoided. More preferably, the following condition is satisfied: −0.20<(R9+R10)/(R9−R10)<2.40.

When a curvature radius of an image-side surface of the first lens element is R2, and a curvature radius of an image-side surface of the second lens element is R4, the following condition is satisfied: 1.65<R2/R4<5.0. Therefore, it is favorable for forming a retro-focus lens structure so as to enlarge the incident angle of the light.

When the central thickness of the third lens element is CT3, a central thickness of the fourth lens element is CT4, a central thickness of the fifth lens element is CT5, and the central thickness of the sixth lens element is CT6, the following condition is satisfied: 0.20<(CT4+CT5+CT6)/CT3<1.50. Therefore, it is favorable for reducing the deformation of the third lens element caused by temperature changes so as to stabilize the image quality and expand the application range.

When the central thickness of the third lens element is CT3, and a sum of central thicknesses of the first lens element, the second lens element, the third lens element, the fourth lens element, the fifth lens element, the sixth lens element and the seventh lens element is ΣCT, the following condition is satisfied: 1.50<ΣCT/CT3<3.50. Therefore, it is favorable for effectively controlling a central thickness proportion of the third lens element in the optical imaging lens assembly, reducing the surface curvature of the third lens element while having the equivalent refractive power, so that excessive aberrations can be avoided, and the light of large field of view can be incident into the optical imaging lens assembly.

When a focal length of the first lens element is f1, a focal length of the second lens element is f2, a focal length of the third lens element is f3, a focal length of the fourth lens element is f4, a focal length of the fifth lens element is f5, a focal length of the sixth lens element is f6, and a focal length of the seventh lens element is f7, a minimum value among absolute values of f1, f2, f3, f4, f5, f6, and f7 is the absolute value of f5. Therefore, it is favorable for adjusting the refractive power value of the fifth lens element so as to correct aberrations.

When the curvature radius of the image-side surface of the fifth lens element is R10, and a curvature radius of an object-side surface of the sixth lens element is R11, the following condition is satisfied: |R10/R11|<0.85. Therefore, it is favorable for assembling the optical imaging lens assembly by adjusting the curvature radii of the image-side surface of the fifth lens element and the object-side surface of the sixth lens element.

When the focal length of the first lens element is f1, the focal length of the second lens element is f2, the focal length of the third lens element is f3, the focal length of the fourth lens element is f4, the focal length of the fifth lens element is f5, the focal length of the sixth lens element is f6, and the focal length of the seventh lens element is f7, the following condition is satisfied: (|f1|+|f2|+|f3|+|f4|+|f5|)/(|f6|+51 f7|)<1.65. Therefore, it is favorable for the sixth lens element and the seventh lens element being as corrective lens elements so as to correct the off-axial aberrations of the optical imaging lens assembly.

When an axial distance between an aperture stop and the image-side surface of the seventh lens element is SD, and an axial distance between an object-side surface of the first lens element and the image-side surface of the seventh lens element is TD, the following condition is satisfied: 0.10<SD/TD<0.52. Therefore, it is favorable for the aperture stop to be located at a balanced position, so that the light of large field of view can be incident into the optical imaging lens assembly, and the advantage of large field of view can be achieved.

When a vertical distance between at least one critical point in an off-axial region on the object-side surface or the image-side surface of the seventh lens element and an optical axis is Yc7x, and the focal length of the optical imaging lens assembly is f, the following condition is satisfied: 0.10<Yc7x/f<2.0. Therefore, it is favorable for properly controlling surface shapes of the seventh lens element so as to correct the off-axial aberrations and reducing the total track length of the optical imaging lens assembly.

When a vertical distance between a maximum effective radius position of the object-side surface of the first lens element and the optical axis is Y11, and a vertical distance between a maximum effective radius position of the image-side surface of the seventh lens element and the optical axis is Y72, the following condition is satisfied: 1.0<Y11/Y72<1.75. Therefore, it is favorable for forming a retro-focus lens structure by balancing an effective radius proportion of the object side lens element to the image side lens element, so that the light of large field of view can be incident into the optical imaging lens assembly, and the imaging range can be enlarged.

When an Abbe number of the third lens element is V3, and an Abbe number of the seventh lens element is V7, the following condition is satisfied: (V3+V7)/2<45.0. Therefore, it is favorable for assisting to correct Petzval Field so as to increase the image quality.

When a half of a maximum field of view of the optical imaging lens assembly is HFOV, the following condition is satisfied: |1/tan(HFOV)|<0.85. Therefore, it is favorable for effectively enlarging the field of view so as to expand the application range.

When a central thickness of the second lens element is CT2, and the central thickness of the third lens element is CT3, the following condition is satisfied: 0<CT2/CT3<0.30. Therefore, it is favorable for moderating the incident light of large field of view by controlling a central thickness proportion of the second lens element to the third lens element so as to reduce the object side photosensitivity of the optical imaging lens assembly.

When a curvature radius of an object-side surface of the third lens element is R5, and a curvature radius of an image-side surface of the third lens element is R6, the following condition is satisfied: −2.80<(R5+R6)/(R5−R6)<0.65. Therefore, it is favorable for enhancing symmetry of the optical imaging lens assembly by adjusting surface shapes of the third lens element so as to reduce the object side photosensitivity.

When an axial distance between the fourth lens element and the fifth lens element is T45, and an axial distance between the fifth lens element and the sixth lens element is T56, the following condition is satisfied: 0.15<T45/T56<3.0. Therefore, it is favorable for adjusting an axial distance proportion among the lens elements so as to enhance the assembling convenience.

When an Abbe number of the seventh lens element is V7, the following condition is satisfied: V7<40.0. Therefore, it is favorable for converging the light with different wavelengths so as to reduce image overlapping.

When a curvature radius of an object-side surface of the fourth lens element is R7, and a curvature radius of an image-side surface of the fourth lens element is R8, the following condition is satisfied: −0.85<(R7+R8)/(R7−R8)<0.85. Therefore, it is favorable for controlling surface shapes of the fourth lens element so as to correct the spherical aberration and reduce the total track length of the optical imaging lens assembly.

According to the optical imaging lens assembly of the present disclosure, the lens elements thereof can be made of plastic or glass materials. When the lens elements are made of plastic materials, the manufacturing cost can be effectively reduced. When the lens elements are made of glass materials, the arrangement of the refractive power of the optical imaging lens assembly may be more flexible to design. Furthermore, surfaces of each lens element can be arranged to be aspheric, since the aspheric surface of the lens element is easy to form a shape other than spherical surface so as to have more controllable variables for eliminating aberrations thereof, and to further decrease the required number of the lens elements. Therefore, the total track length of the optical imaging lens assembly can also be reduced.

According to the optical imaging lens assembly of the present disclosure, each of an object-side surface and an image-side surface has a paraxial region and an off-axial region. The paraxial region refers to the region of the surface where light rays travel close to an optical axis, and the off-axial region refers to the region of the surface away from the paraxial region. Particularly unless otherwise specified, when the lens element has a convex surface, it indicates that the surface can be convex in the paraxial region thereof; when the lens element has a concave surface, it indicates that the surface can be concave in the paraxial region thereof. According to the optical imaging lens assembly of the present disclosure, the refractive power or the focal length of a lens element being positive or negative may refer to the refractive power or the focal length in a paraxial region of the lens element.

According to the optical imaging lens assembly of the present disclosure, a critical point is a non-axial point of the lens surface where its tangent is perpendicular to the optical axis.

According to the optical imaging lens assembly of the present disclosure, the optical imaging lens assembly can include at least one stop, such as an aperture stop, a glare stop or a field stop. The glare stop or the field stop is for eliminating the stray light and thereby improving the image resolution thereof.

According to the optical imaging lens assembly of the present disclosure, the image surface, depending on the corresponding image sensor, can be a planar surface or a curved surface with any curvature, particularly a curved surface being concave toward the object side.

According to the optical imaging lens assembly of the present disclosure, an aperture stop can be configured as a front stop or a middle stop. A front stop disposed between an imaged object and the first lens element can provide a longer distance between an exit pupil of the optical imaging lens assembly and the image surface to enable a telecentric effect, and thereby can improve the image-sensing efficiency of an image sensor. A middle stop disposed between the first lens element and the image surface is favorable for enlarging the field of view of the optical imaging lens assembly and thereby provides a wider field of view for the same.

According to the optical imaging lens assembly of the present disclosure, the optical imaging lens assembly can be optionally applied to moving focus optical systems. Furthermore, the optical imaging lens assembly is featured with good correction ability and high image quality, and can be applied to 3D (three-dimensional) image capturing applications, in products such as digital cameras, mobile devices, digital tablets, smart TVs, network monitoring devices, motion sensing input devices, driving recorders, rear view camera systems, extreme sports cameras, industrial robots, wearable devices and other electronic imaging products.

According to the present disclosure, an image capturing apparatus is provided. The image capturing apparatus includes the aforementioned optical imaging lens assembly according to the present disclosure and an image sensor, wherein the image sensor is disposed on or near the image surface of the aforementioned optical imaging lens assembly. Therefore, it is favorable for the image capturing apparatus to achieve the features of large field of view, compact size, resistance to environmental changes and high image quality by the proper arrangement of lens elements so as to be applicable to wider range of products. Preferably, the image capturing apparatus can further include a barrel member, a holder member or a combination thereof.

According to the present disclosure, an electronic device is provided, wherein the electronic device includes the aforementioned image capturing apparatus. Therefore, it is favorable for simultaneously satisfying the requirement of compact size and enhancing the image quality. Preferably, the electronic device can further include but not limited to a control unit, a display, a storage unit, a random access memory unit (RAM) or a combination thereof.

According to the above description of the present disclosure, the following 1st-15th specific embodiments are provided for further explanation.

### 1st Embodiment

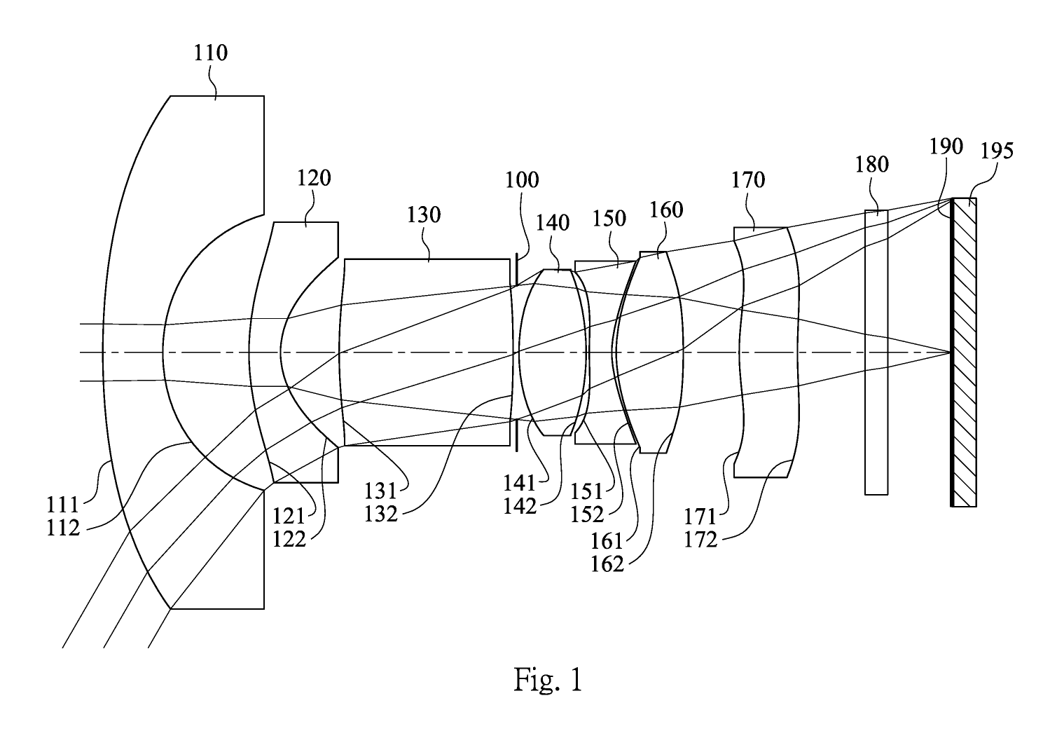

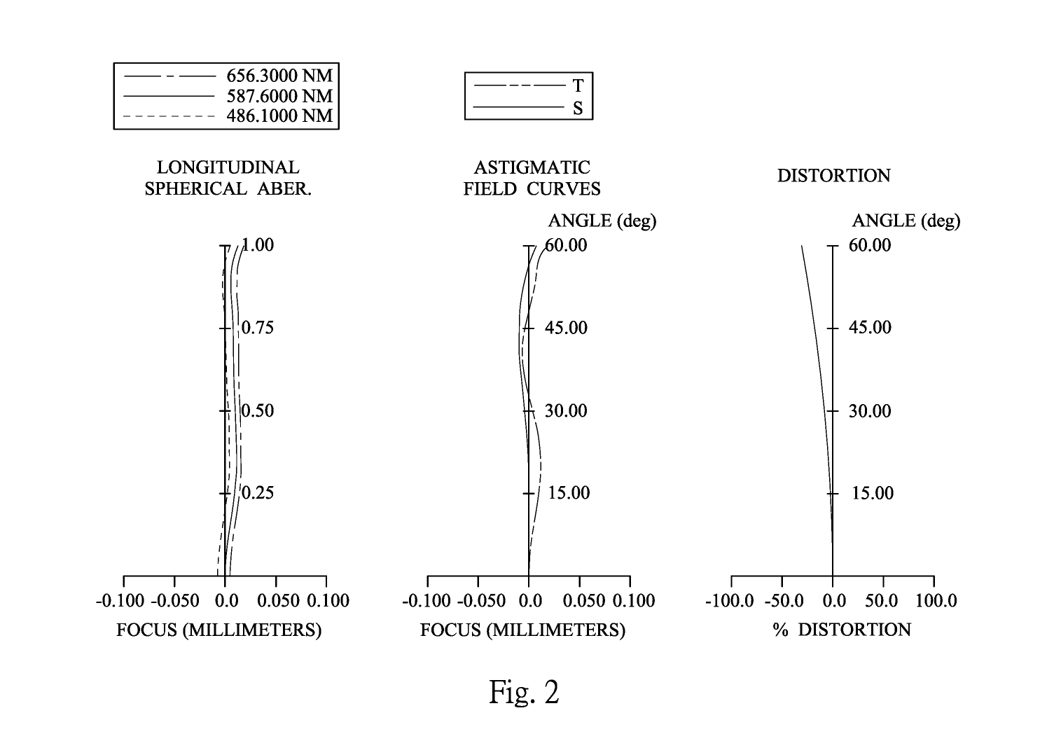

FIG. 1 is a schematic view of an image capturing apparatus according to the 1st embodiment of the present disclosure. FIG. 2 shows, in order from left to right, spherical aberration curves, astigmatic field curves and a distortion curve of the image capturing apparatus according to the 1st embodiment. In FIG. 1, the image capturing apparatus includes the optical imaging lens assembly (its reference numeral is omitted) and an image sensor 195. The optical imaging lens assembly includes, in order from an object side to an image side, a first lens element 110, a second lens element 120, a third lens element 130, an aperture stop 100, a fourth lens element 140, a fifth lens element 150, a sixth lens element 160, a seventh lens element 170, a filter 180 and an image surface 190. The image sensor 195 is disposed on the image surface 190 of the optical imaging lens assembly. The optical imaging lens assembly has a total of seven lens elements (110-170). Moreover, there is an air gap between every two of the first lens element 110, the second lens element 120, the third lens element 130, the fourth lens element 140, the fifth lens element 150, the sixth lens element 160 and the seventh lens element 170 that are adjacent to each other.

The first lens element 110 with negative refractive power has an object-side surface 111 being convex in a paraxial region thereof and an image-side surface 112 being concave in a paraxial region thereof. The first lens element 110 is made of a plastic material, and has the object-side surface 111 and the image-side surface 112 being both aspheric.

The second lens element 120 with negative refractive power has an object-side surface 121 being convex in a paraxial region thereof and an image-side surface 122 being concave in a paraxial region thereof. The second lens element 120 is made of a plastic material, and has the object-side surface 121 and the image-side surface 122 being both aspheric.

The third lens element 130 with positive refractive power has an object-side surface 131 being convex in a paraxial region thereof and an image-side surface 132 being convex in a paraxial region thereof. The third lens element 130 is made of a plastic material, and has the object-side surface 131 and the image-side surface 132 being both aspheric.

The fourth lens element 140 with positive refractive power has an object-side surface 141 being convex in a paraxial region thereof and an image-side surface 142 being convex in a paraxial region thereof. The fourth lens element 140 is made of a plastic material, and has the object-side surface 141 and the image-side surface 142 being both aspheric.

The fifth lens element 150 with negative refractive power has an object-side surface 151 being convex in a paraxial region thereof and an image-side surface 152 being concave in a paraxial region thereof. The fifth lens element 150 is made of a plastic material, and has the object-side surface 151 and the image-side surface 152 being both aspheric.

The sixth lens element 160 with positive refractive power has an object-side surface 161 being convex in a paraxial region thereof and an image-side surface 162 being convex in a paraxial region thereof. The sixth lens element 160 is made of a plastic material, and has the object-side surface 161 and the image-side surface 162 being both aspheric.

The seventh lens element 170 with positive refractive power has an object-side surface 171 being convex in a paraxial region thereof and an image-side surface 172 being concave in a paraxial region thereof. The seventh lens element 170 is made of a plastic material, and has the object-side surface 171 and the image-side surface 172 being both aspheric. Furthermore, the object-side surface 171 of the seventh lens element 170 includes at least one concave shape in an off-axial region thereof, and the object-side surface 171 and the image-side surface 172 of the seventh lens element 170 both include at least one inflection point.

The filter 180 is made of a glass material and located between the seventh lens element 170 and the image surface 190, and will not affect the focal length of the optical imaging lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) * ( {Y}^{i} ) ,$$

where,

X is the relative distance between a point on the aspheric surface spaced at a distance Y from the optical axis and the tangential plane at the aspheric surface vertex on the optical axis;

Y is the vertical distance from the point on the aspheric surface to the optical axis;

R is the curvature radius;

k is the conic coefficient; and

Ai is the i-th aspheric coefficient.

In the optical imaging lens assembly according to the 1st embodiment, when a focal length of the optical imaging lens assembly is f, an f-number of the optical imaging lens assembly is Fno, and half of a maximum field of view of the optical imaging lens assembly is HFOV, these parameters have the following values: f=2.83 mm; Fno=2.24; and HFOV=60.0 degrees.

In the optical imaging lens assembly according to the 1st embodiment, when the half of a maximum field of view of the optical imaging lens assembly is HFOV, the following condition is satisfied: |1/tan(HFOV)|=0.58.

In the optical imaging lens assembly according to the 1st embodiment, when an Abbe number of the seventh lens element 170 is V7, the following condition is satisfied: V7=55.8.

In the optical imaging lens assembly according to the 1st embodiment, when an Abbe number of the third lens element 130 is V3, and an Abbe number of the seventh lens element 170 is V7, the following condition is satisfied: (V3+V7)/2=38.08.

In the optical imaging lens assembly according to the 1st embodiment, when a central thickness of the second lens element 120 is CT2, and the central thickness of the third lens element 130 is CT3, the following condition is satisfied: CT2/CT3=0.18.

In the optical imaging lens assembly according to the 1st embodiment, when the central thickness of the third lens element 130 is CT3, and a central thickness of the sixth lens element 160 is CT6, the following condition is satisfied: CT6/CT3=0.39.

In the optical imaging lens assembly according to the 1st embodiment, when the central thickness of the third lens element 130 is CT3, a central thickness of the fourth lens element 140 is CT4, a central thickness of the fifth lens element 150 is CT5, and the central thickness of the sixth lens element 160 is CT6, the following condition is satisfied: (CT4+CT5+CT6)/GT3=0.90.

In the optical imaging lens assembly according to the 1st embodiment, when a central thickness of the first lens element 110 is CT1, the central thickness of the second lens element 120 is CT2, the central thickness of the third lens element 130 is CT3, the central thickness of the fourth lens element 140 is CT4, the central thickness of the fifth lens element 150 is CT5, the central thickness of the sixth lens element 160 is CT6, the central thickness of the seventh lens element 170 is CT7, and a sum of central thicknesses of the first lens element 110, the second lens element 120, the third lens element 130, the fourth lens element 140, the fifth lens element 150, the sixth lens element 160 and the seventh lens element 170 is ΣCT ΣCT=CT1+CT2+CT3+CT4+CT5+CT6+CT7), the following condition is satisfied: ΣCT/CT3=2.76.

In the optical imaging lens assembly according to the 1st embodiment, when an axial distance between the fourth lens element 140 and the fifth lens element 150 is T45, and an axial distance between the fifth lens element 150 and the sixth lens element 160 is T56, the following condition is satisfied: T45/T56=0.73.

In the optical imaging lens assembly according to the 1st embodiment, when a curvature radius of the object-side surface 131 of the third lens element 130 is R5, and a curvature radius of the image-side surface 132 of the third lens element 130 is R6, the following condition is satisfied: (R5+R6)/(R5−R6)=−0.46.

In the optical imaging lens assembly according to the 1st embodiment, when a curvature radius of the object-side surface 141 of the fourth lens element 140 is R7, and a curvature radius of the image-side surface 142 of the fourth lens 140 element is R8, the following condition is satisfied: (R7+R8)/(R7−R8)=−0.19.

In the optical imaging lens assembly according to the 1st embodiment, when a curvature radius of the object-side surface 151 of the fifth lens element 150 is R9, and a curvature radius of the image-side surface 152 of the fifth lens element 150 is R10, the following condition is satisfied: (R9+R10)/(R9−R10)=1.60.

In the optical imaging lens assembly according to the 1st embodiment, when a curvature radius of the image-side surface 112 of the first lens element 110 is R2, and a curvature radius of the image-side surface 122 of the second lens element 120 is R4, the following condition is satisfied: R2/R4=2.05.

In the optical imaging lens assembly according to the 1st embodiment, when the curvature radius of the image-side surface 152 of the fifth lens element 150 is R10, and a curvature radius of the object-side surface 161 of the sixth lens element 160 is R11, the following condition is satisfied: |R10/R11|=0.70.

In the optical imaging lens assembly according to the 1st embodiment, when the focal length of the optical imaging lens assembly is f, and an axial distance between the sixth lens element 160 and the seventh lens element 170 is T67, the following condition is satisfied: f/T67=2.28.

In the optical imaging lens assembly according to the 1st embodiment, when a focal length of the first lens element 110 is f1, a focal length of the second lens element 120 is f2, a focal length of the third lens element 130 is f3, a focal length of the fourth lens element 140 is f4, a focal length of the fifth lens element 150 is f5, a focal length of the sixth lens element 160 is f6, and a focal length of the seventh lens element 170 is f7, the following condition is satisfied: (|f1|+|f2|+|f3|+|f4|+|f5|)/(|f6|+|f7|)=1.62.

In the optical imaging lens assembly according to the 1st embodiment, when an axial distance between the aperture stop 100 and the image-side surface 172 of the seventh lens element 170 is SD, and an axial distance between the object-side surface 111 of the first lens element 110 and the image-side surface 172 of the seventh lens element 170 is TD, the following condition is satisfied: SD/TD=0.40.

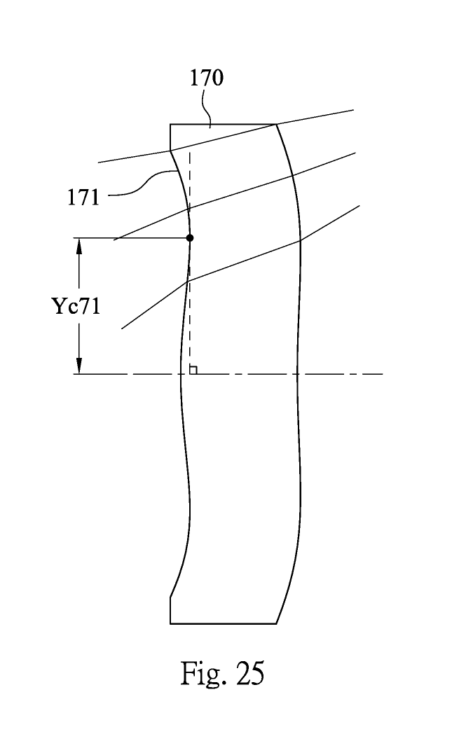

FIG. 25 shows a schematic view of the parameter Yc71 of the optical is imaging lens assembly of the image capturing apparatus according to FIG. 1. In the optical imaging lens assembly according to the 1st embodiment, a vertical distance between at least one critical point in an off-axial region on the object-side surface 171 or the image-side surface 172 of the seventh lens element 170 and the optical axis is Yc7x. In FIG. 25, when the vertical distance between the critical point in the off-axial region on the object-side surface 171 of the seventh lens element 170 and the optical axis is Yc71, which satisfies the parameter Yc7x claimed in the present disclosure, and the focal length of the optical imaging lens assembly is f, the following condition is satisfied: Yc71/f=0.53.

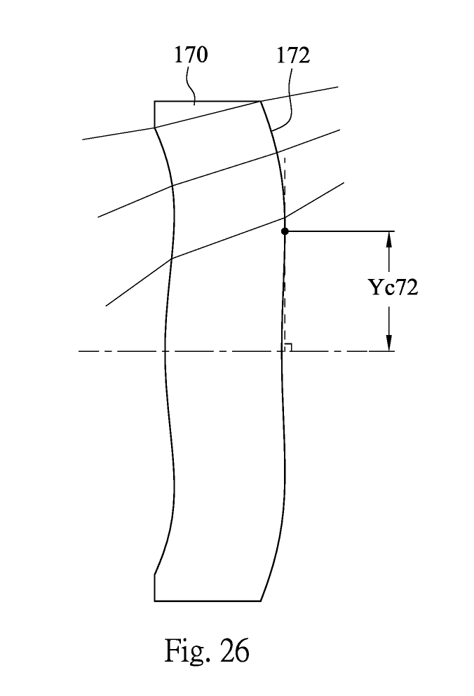

FIG. 26 shows a schematic view of the parameter Yc72 of the optical imaging lens assembly of the image capturing apparatus according to FIG. 1. In FIG. 26, when the vertical distance between the critical point in the off-axial region on the image-side surface 172 of the seventh lens element 170 and the optical axis is Yc72, which satisfies the parameter Yc7x claimed in the present disclosure, and the focal length of the optical imaging lens assembly is f, the following condition is satisfied: Yc72/f=0.47.

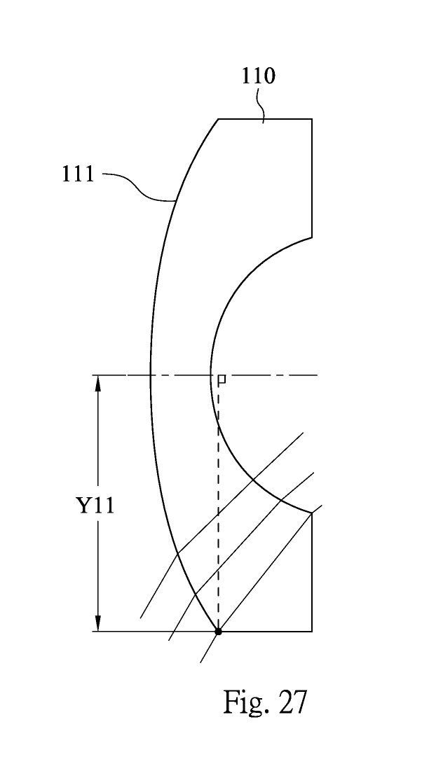

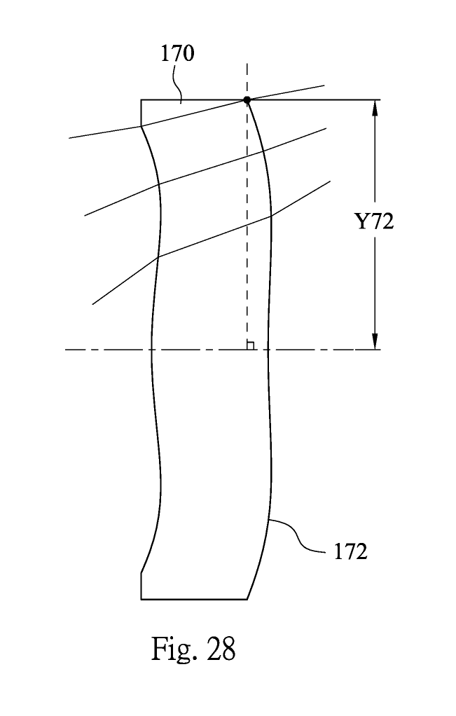

FIG. 27 shows a schematic view of the parameter Y11 of the optical imaging lens assembly of the image capturing apparatus according to FIG. 1. to FIG. 28 shows a schematic view of the parameter Y72 of the optical imaging lens assembly of the image capturing apparatus according to FIG. 1. In FIG. 27 and FIG. 28, when a vertical distance between a maximum effective radius position of the object-side surface 111 of the first lens element 110 and the optical axis is Y11, and a vertical distance between a maximum effective radius position of the image-side surface 172 of the seventh lens element 170 and the optical axis is Y72, the following condition is satisfied: Y11/Y72=2.05.

In the optical imaging lens assembly according to the 1st embodiment, when a focal length of the first lens element 110 is 11, a focal length of the second lens element 120 is f2, a focal length of the third lens element 130 is f3, a focal length of the fourth lens element 140 is f4, a focal length of the fifth lens element 150 is f5, a focal length of the sixth lens element 160 is f6, and a focal length of the seventh lens element 170 is f7, a minimum value among absolute values of f1, f2, f3, f4, f5, f6, and f7 is the absolute value of f5.

The detailed optical data of the 1st embodiment are shown in TABLE 1 and the aspheric surface data are shown in TABLE 2 below.

TABLE 1
1st Embodiment
f = 2.83 mm, Fno = 2.24, HFOV = 60.0 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Lens 1 | 16.087 | ASP | 1.332 | Plastic | 1.544 | 55.9 | −8.98 |
| 2 | | 3.636 | ASP | 1.911 | | | | |
| 3 | Lens 2 | 5.327 | ASP | 0.700 | Plastic | 1.544 | 55.9 | −5.27 |
| 4 | | 1.776 | ASP | 1.300 | | | | |
| 5 | Lens 3 | 10.308 | ASP | 3.860 | Plastic | 1.660 | 20.4 | 11.88 |
| 6 | | −27.846 | ASP | 0.080 | | | | |
| 7 | Ape. Stop | Plano | | 0.050 | | | | |
| 8 | Lens 4 | 4.022 | ASP | 1.491 | Plastic | 1.535 | 55.8 | 4.73 |
| 9 | | −5.953 | ASP | 0.070 | | | | |
| 10 | Lens 5 | 9.146 | ASP | 0.500 | Plastic | 1.639 | 23.5 | −4.40 |
| 11 | | 2.105 | ASP | 0.096 | | | | |
| 12 | Lens 6 | 3.020 | ASP | 1.488 | Plastic | 1.535 | 55.8 | 4.89 |
| 13 | | −16.125 | ASP | 1.242 | | | | |
| 14 | Lens 7 | 5.345 | ASP | 1.293 | Plastic | 1.535 | 55.8 | 16.86 |
| 15 | | 12.019 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.430 | | | | |
| 18 | Image | Plano | — | | | | |

Reference wavelength is 587.6 nm (d-line).

TABLE 2
Aspheric Coefficients

| Surface # | 1 | 2 | 3 | 4 | 5 | 6 | 8 |
|---|---|---|---|---|---|---|---|
| k = | 4.5687E+00 | 3.0894E−01 | 3.2184E−01 | −4.7909E−01 | −4.9071E+01 | 9.0000E+01 | 2.5270E+00 |
| A4 = | 4.5106E−04 | 1.9498E−03 | −6.4239E−03 | −1.4066E−02 | 2.1184E−03 | −6.2606E−03 | −1.7648E−03 |
| A6 = | −1.7037E−05 | 1.5443E−05 | 1.1977E−03 | 2.0708E−03 | −8.8488E−04 | 1.9158E−03 | 9.8575E−04 |
| A8 = | 4.0634E−07 | −4.5817E−07 | −2.1386E−04 | −5.1898E−04 | 1.3097E−04 | −7.0204E−04 | −2.0253E−04 |
| A10 = | −3.7385E−09 | 6.2019E−07 | 1.2976E−05 | −4.3079E−05 | −3.0831E−05 | 1.1138E−04 | |
| A12 = | | | −1.8276E−07 | | | | |
| Surface # | 9 | 10 | 11 | 12 | 13 | 14 | 15 |
| k = | −5.3461E+00 | −4.1845E+01 | −8.6015E+00 | −1.9622E+01 | 4.2482E+00 | −1.6948E+01 | −9.0000E+01 |
| A4 = | −3.1333E−02 | −8.1963E−02 | −3.8511E−04 | 2.5734E−02 | −2.3200E−02 | −1.2309E−02 | −7.6517E−03 |
| A6 = | 2.0834E−02 | 3.3552E−02 | −1.3006E−03 | −1.2657E−02 | 6.8126E−03 | −3.1655E−04 | −2.6044E−04 |
| A8 = | −6.3540E−03 | −9.6069E−03 | 2.3706E−03 | 5.1067E−03 | −2.1618E−03 | −6.5996E−05 | 3.7352E−05 |
| A10 = | 6.5681E−04 | 8.6533E−04 | −8.3568E−04 | −1.0775E−03 | 4.3353E−04 | 1.6703E−05 | 6.3695E−07 |
| A12 = | | | 8.8837E−05 | 8.5058E−05 | −3.1579E−05 | | |

In TABLE 1, the curvature radius, the thickness and the focal length are shown in millimeters (mm). Surface numbers 0-18 represent the surfaces sequentially arranged from the object-side to the image-side along the optical axis. In TABLE 2, k represents the conic coefficient of the equation of the aspheric surface profiles. A4-A12 represent the aspheric coefficients ranging from the 4th order to the 12th order. The tables presented below for each embodiment are the corresponding schematic parameter and aberration curves, and the definitions of the tables are the same as TABLE 1 and TABLE 2 of the 1st embodiment. Therefore, an explanation in this regard will not be provided again.

### 2nd Embodiment

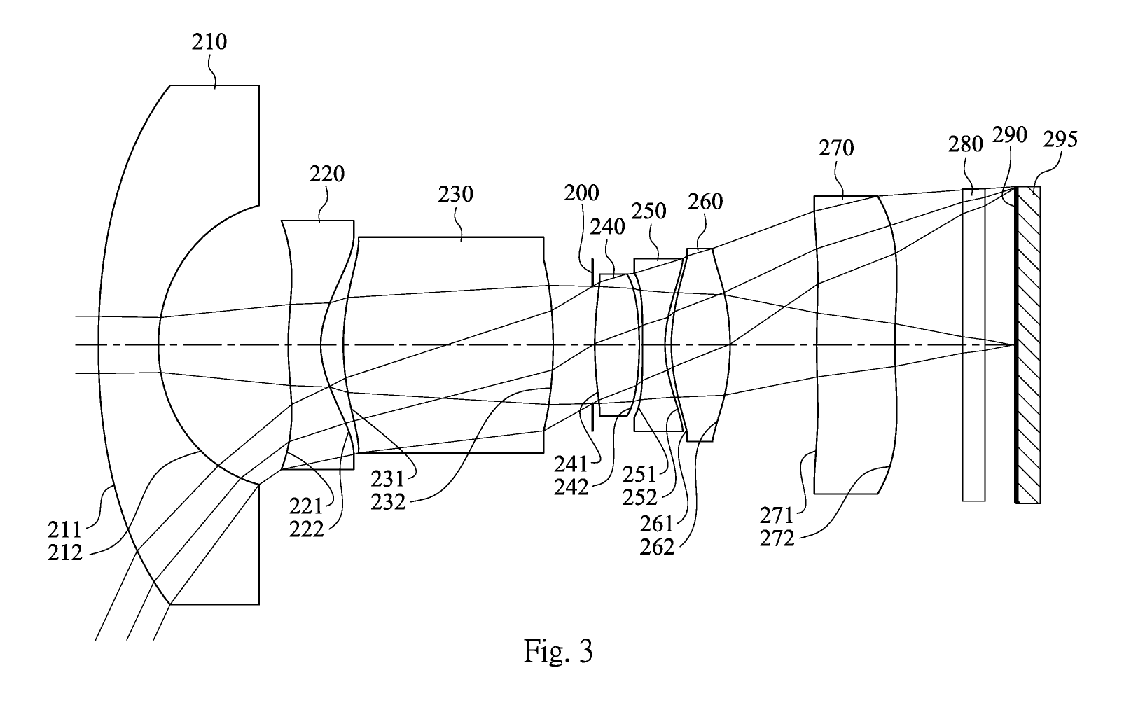

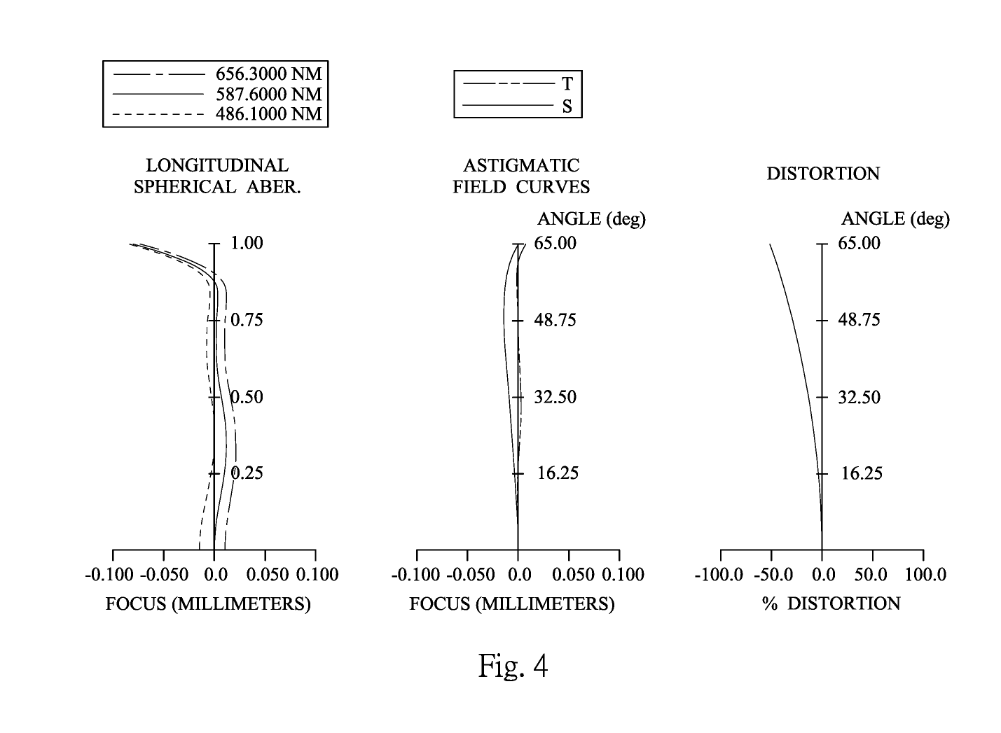

FIG. 3 is a schematic view of an image capturing apparatus according to the 2nd embodiment of the present disclosure. FIG. 4 shows, in order from left to right, spherical aberration curves, astigmatic field curves and a distortion curve of the image capturing apparatus according to the 2nd embodiment. In FIG. 3, the image capturing apparatus includes the optical imaging lens assembly (its reference numeral is omitted) and an image sensor 295. The optical imaging lens assembly includes, in order from an object side to an image side, a first lens element 210, a second lens element 220, a third lens element 230, an aperture stop 200, a fourth lens element 240, a fifth lens element 250, a sixth lens element 260, a seventh lens element 270, a filter 280 and an image surface 290. The image sensor 295 is disposed on the image surface 290 of the optical imaging lens assembly. The optical imaging lens assembly has a total of seven lens elements (210-270). Moreover, there is an air gap between every two of the first lens element 210, the second lens element 220, the third lens element 230, the fourth lens element 240, the fifth lens element 250, the sixth lens element 260 and the seventh lens element 270 that are adjacent to each other.

The first lens element 210 with negative refractive power has an object-side surface 211 being convex in a paraxial region thereof and an image-side surface 212 being concave in a paraxial region thereof. The first lens element 210 is made of a glass material, and has the object-side surface 211 and the image-side surface 212 being both aspheric.

The second lens element 220 with negative refractive power has an object-side surface 221 being convex in a paraxial region thereof and an image-side surface 222 being concave in a paraxial region thereof. The second lens element 220 is made of a plastic material, and has the object-side surface 221 and the image-side surface 222 being both aspheric.

The third lens element 230 with positive refractive power has an object-side surface 231 being convex in a paraxial region thereof and an image-side surface 232 being convex in a paraxial region thereof. The third lens element 230 is made of a glass material, and has the object-side surface 231 and the image-side surface 232 being both aspheric.

The fourth lens element 240 with positive refractive power has an object-side surface 241 being convex in a paraxial region thereof and an image-side surface 242 being convex in a paraxial region thereof. The fourth lens element 240 is made of a plastic material, and has the object-side surface 241 and the image-side surface 242 being both aspheric.

The fifth lens element 250 with negative refractive power has an object-side surface 251 being convex in a paraxial region thereof and an image-side surface 252 being concave in a paraxial region thereof. The fifth lens element 250 is made of a plastic material, and has the object-side surface 251 and the image-side surface 252 being both aspheric.

The sixth lens element 260 with positive refractive power has an object-side surface 261 being convex in a paraxial region thereof and an image-side surface 262 being convex in a paraxial region thereof. The sixth lens element 260 is made of a plastic material, and has the object-side surface 261 and the image-side surface 262 being both aspheric.

The seventh lens element 270 with negative refractive power has an object-side surface 271 being convex in a paraxial region thereof and an image-side surface 272 being concave in a paraxial region thereof. The seventh lens element 270 is made of a plastic material, and has the object-side surface 271 and the image-side surface 272 being both aspheric. Furthermore, the object-side surface 271 of the seventh lens element 270 includes at least one concave shape in an off-axial region thereof, and the object-side surface 271 and the image-side surface 272 of the seventh lens element 270 both include at least one inflection point.

The filter 280 is made of a glass material and located between the seventh lens element 270 and the image surface 290, and will not affect the focal length of the optical imaging lens assembly.

The detailed optical data of the 2nd embodiment are shown in TABLE 3 and the aspheric surface data are shown in TABLE 4 below.

TABLE 3
2nd Embodiment
f = 3.36 mm, Fno = 2.65, HFOV = 65.0 deg.

| | | | | | | | | Focal |
|---|---|---|---|---|---|---|---|---|
| Surface # | | Curvature Radius | | Thickness | Material | Index | Abbe # | Length |
| 0 | Object | Plano | | Infinity | | | | |
| 1 | Lens 1 | 16.087 | ASP | 1.332 | Glass | 1.757 | 48.6 | −6.51 |
| 2 | | 3.636 | ASP | 2.880 | | | | |
| 3 | Lens 2 | 6.573 | ASP | 0.722 | Plastic | 1.544 | 55.9 | −5.38 |
| 4 | | 1.947 | ASP | 0.501 | | | | |
| 5 | Lens 3 | 5.364 | ASP | 4.657 | Glass | 1.897 | 35.2 | 4.52 |
| 6 | | −9.821 | ASP | 0.873 | | | | |
| 7 | Ape. Stop | Plano | | 0.050 | | | | |
| 8 | Lens 4 | 7.375 | ASP | 0.988 | Plastic | 1.535 | 55.8 | 7.38 |
| 9 | | −8.097 | ASP | 0.070 | | | | |
| 10 | Lens 5 | 52.632 | ASP | 0.600 | Plastic | 1.639 | 23.5 | −4.29 |
| 11 | | 2.593 | ASP | 0.141 | | | | |
| 12 | Lens 6 | 3.827 | ASP | 1.302 | Plastic | 1.535 | 55.8 | 4.46 |
| 13 | | −5.578 | ASP | 1.922 | | | | |
| 14 | Lens 7 | 17.384 | ASP | 1.738 | Plastic | 1.535 | 55.8 | −112.12 |
| 15 | | 13.008 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 0.691 | | | | |
| 18 | Image | Plano | — | | | | |

Reference wavelength is 587.6 nm (d-line).

TABLE 4
Aspheric Coefficients

| Surface # | 1 | 2 | 3 | 4 | 5 | 6 | 8 |
|---|---|---|---|---|---|---|---|
| k = | 4.5687E+00 | 3.0894E−01 | −9.8546E+00 | −5.5559E−01 | −1.1249E+00 | 8.8641E+00 | 3.1200E+00 |
| A4 = | 4.7804E−04 | 1.2976E−03 | −1.9614E−02 | −3.9355E−02 | −1.8471E−03 | −2.0074E−03 | −1.1937E−02 |
| A6 = | −1.7037E−05 | −3.7519E−05 | 2.2534E−03 | 3.1099E−03 | −4.2693E−04 | 1.0391E−03 | 5.3075E−03 |
| A8 = | 4.0634E−07 | −1.3095E−06 | −2.1833E−04 | −4.3909E−04 | 4.8150E−06 | −2.2329E−04 | −1.5568E−03 |
| A10 = | −3.7384E−09 | −4.3127E−08 | 1.2361E−05 | 6.8192E−06 | −9.3944E−06 | 1.4156E−05 | |
| A12 = | | | −1.8276E−07 | | | | |
| Surface # | 9 | 10 | 11 | 12 | 13 | 14 | 15 |
| k = | −3.9280E−01 | −4.1845E+01 | −5.1742E+00 | −1.8512E+01 | −2.1524E+01 | −9.0000E+01 | −9.0000E+01 |
| A4 = | −3.2231E−02 | −4.3610E−02 | −4.1986E−03 | 1.8286E−02 | −2.3631E−02 | −8.3175E−03 | −6.1934E−03 |
| A6 = | 2.2114E−02 | 1.6454E−02 | −5.2198E−03 | −1.3105E−02 | 6.9877E−03 | 9.7442E−04 | 1.8642E−04 |
| A8 = | −7.8852E−03 | −4.4435E−03 | 3.9254E−03 | 5.7966E−03 | −1.7362E−03 | −5.9807E−05 | −1.7296E−05 |
| A10 = | 3.8560E−04 | −7.0886E−05 | −1.1190E−03 | −1.2083E−03 | 3.7896E−04 | 2.1464E−06 | 8.1108E−07 |
| A12 = | | | 9.8158E−05 | 8.5058E−05 | −3.1579E−05 | | |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from TABLE 3 and TABLE 4 as the following values and satisfy the following conditions:

2nd Embodiment

| | | | |
|---|---|---|---|
| f (mm) | 3.36 | (R5 + R6)/(R5 − R6) | −0.29 |
| Fno | 2.65 | (R7 + R8)/(R7 − R8) | −0.05 |
| HFOV (deg.) | 65.0 | (R9 + R10)/(R9 − R10) | 1.10 |
| \|1/tan(HFOV)\| | 0.47 | R2/R4 | 1.87 |
| V7 | 55.8 | \|R10/R11\| | 0.68 |
| (V3 + V7)/2 | 45.48 | f/T67 | 1.75 |
| CT2/CT3 | 0.16 | (\|f1\| + \|f2\| + \|f3\| + \|f4\| + | 0.24 |
| | | \|f5\|)/(\|f6\| + \|f7\|) | |
| CT6/CT3 | 0.28 | SD/TD | 0.38 |
| (CT4 + CT5 + CT6)/CT3 | 0.60 | Yc71/f | 0.42 |
| ΣCT/CT3 | 2.41 | Yc72/f | 0.45 |
| T45/T56 | 0.50 | Y11/Y72 | 1.74 |

Furthermore, in the optical imaging lens assembly according to the 2nd embodiment, when a focal length of the first lens element 210 is f1, a focal length of the second lens element 220 is f2, a focal length of the third lens element 230 is f3, a focal length of the fourth lens element 240 is f4, a focal length of the fifth lens element 250 is f5, a focal length of the sixth lens element 260 is f6, and a focal length of the seventh lens element 270 is f7, a minimum value among absolute values of f1, f2, f3, f4, f5, f6, and f7 is the absolute value of f5.

### 3rd Embodiment

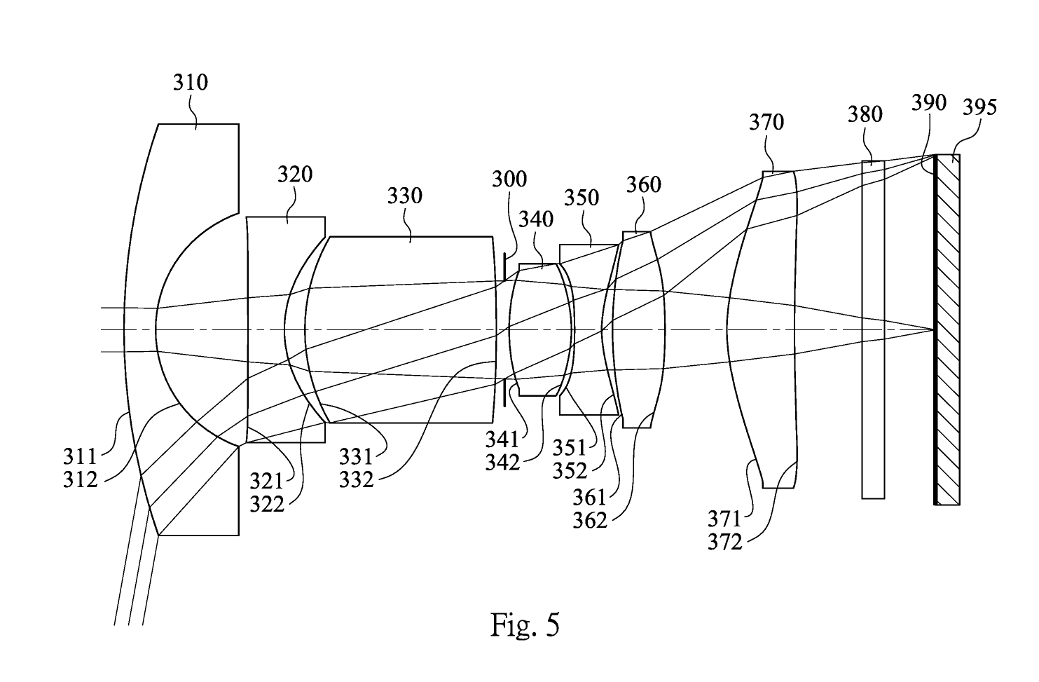

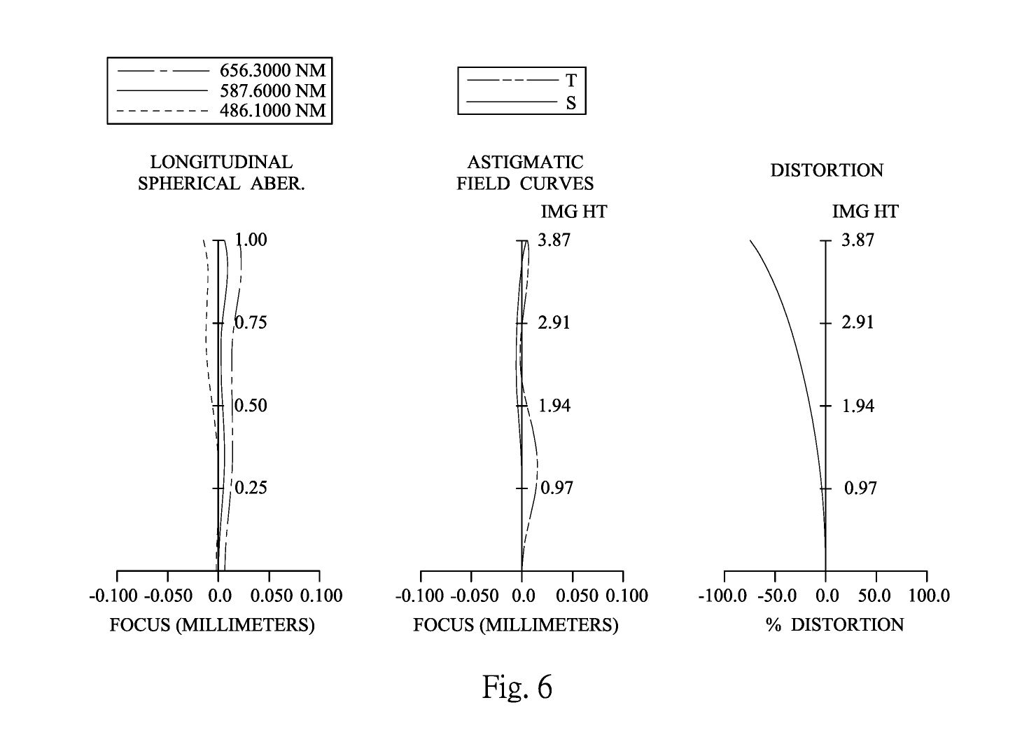

FIG. 5 is a schematic view of an image capturing apparatus according to the 3rd embodiment of the present disclosure. FIG. 6 shows, in order from left to right, spherical aberration curves, astigmatic field curves and a distortion curve of the image capturing apparatus according to the 3rd embodiment. In FIG. 5, the image capturing apparatus includes the optical imaging lens assembly (its reference numeral is omitted) and an image sensor 395. The optical imaging lens assembly includes, in order from an object side to an image side, a first lens element 310, a second lens element 320, a third lens element 330, an aperture stop 300, a fourth lens element 340, a fifth lens element 350, a sixth lens element 360, a seventh lens element 370, a filter 380 and an image surface 390. The image sensor 395 is disposed on the image surface 390 of the optical imaging lens assembly. The optical imaging lens assembly has a total of seven lens elements (310-370). Moreover, there is an air gap between every two of the first lens element 310, the second lens element 320, the third lens element 330, the fourth lens element 340, the fifth lens element 350, the sixth lens element 360 and the seventh lens element 370 that are adjacent to each other.

The first lens element 310 with negative refractive power has an object-side surface 311 being convex in a paraxial region thereof and an image-side surface 312 being concave in a paraxial region thereof. The first lens element 310 is made of a glass material, and has the object-side surface 311 and the image-side surface 312 being both spherical.

The second lens element 320 with negative refractive power has an object-side surface 321 being concave in a paraxial region thereof and an image-side surface 322 being concave in a paraxial region thereof. The second lens element 320 is made of a plastic material, and has the object-side surface 321 and the image-side surface 322 being both aspheric.

The third lens element 330 with positive refractive power has an object-side surface 331 being convex in a paraxial region thereof and an image-side surface 332 being convex in a paraxial region thereof. The third lens element 330 is made of a glass material, and has the object-side surface 331 and the image-side surface 332 being both spherical.

The fourth lens element 340 with positive refractive power has an object-side surface 341 being convex in a paraxial region thereof and an image-side surface 342 being convex in a paraxial region thereof. The fourth lens element 340 is made of a plastic material, and has the object-side surface 341 and the image-side surface 342 being both aspheric.

The fifth lens element 350 with negative refractive power has an object-side surface 351 being concave in a paraxial region thereof and an image-side surface 352 being concave in a paraxial region thereof. The fifth lens element 350 is made of a plastic material, and has the object-side surface 351 and the image-side surface 352 being both aspheric.

The sixth lens element 360 with positive refractive power has an object-side surface 361 being convex in a paraxial region thereof and an image-side surface 362 being convex in a paraxial region thereof. The sixth lens element 360 is made of a plastic material, and has the object-side surface 361 and the image-side surface 362 being both aspheric.

The seventh lens element 370 with positive refractive power has an object-side surface 371 being convex in a paraxial region thereof and an image-side surface 372 being concave in a paraxial region thereof. The seventh lens element 370 is made of a plastic material, and has the object-side surface 371 and the image-side surface 372 being both aspheric. Furthermore, the object-side surface 371 of the seventh lens element 370 includes at least one concave shape in an off-axial region thereof, and the object-side surface 371 and the image-side surface 372 of the seventh lens element 370 both include at least one inflection point.

The filter 380 is made of a glass material and located between the seventh lens element 370 and the image surface 390, and will not affect the focal length of the optical imaging lens assembly.

The detailed optical data of the 3rd embodiment are shown in TABLE 5and the aspheric surface data are shown in TABLE 6 below.

TABLE 5
3rd Embodiment
f = 2.74 mm, Fno = 2.80, HFOV = 79.9 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 13.956 | | 0.700 | Glass | 1.804 | 46.5 | −4.35 |
| 2 | | 2.735 | | 2.050 | | | | |
| 3 | Lens 2 | −100.000 | ASP | 0.808 | Plastic | 1.544 | 55.9 | −4.54 |
| 4 | | 2.540 | ASP | 0.454 | | | | |
| 5 | Lens 3 | 4.091 | | 4.251 | Glass | 1.946 | 32.0 | 3.99 |
| 6 | | −24.472 | | 0.180 | | | | |
| 7 | Ape. Stop | Plano | | 0.100 | | | | |
| 8 | Lens 4 | 4.675 | ASP | 1.382 | Plastic | 1.544 | 55.9 | 3.45 |
| 9 | | −2.806 | ASP | 0.071 | | | | |
| 10 | Lens 5 | −10.217 | ASP | 0.600 | Plastic | 1.639 | 23.5 | −3.09 |
| 11 | | 2.503 | ASP | 0.239 | | | | |
| 12 | Lens 6 | 7.388 | ASP | 1.165 | Plastic | 1.544 | 55.9 | 9.10 |
| 13 | | −14.155 | ASP | 1.374 | | | | |
| 14 | Lens 7 | 4.168 | ASP | 1.498 | Plastic | 1.544 | 55.9 | 8.47 |
| 15 | | 38.245 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.128 | | | | |
| 18 | Image | Plano | — | | | | |

Reference wavelength is 587.6 nm (d-line).

TABLE 6
Aspheric Coefficients

| Surface # | 3 | 4 | 8 | 9 | 10 |
|---|---|---|---|---|---|
| k = | 8.0853E+01 | 1.9078E−02 | 8.4815E−01 | −1.3749E+01 | −2.9746E+01 |
| A4 = | 2.8757E−03 | −4.6650E−04 | 8.9221E−03 | −2.6160E−02 | −3.9381E−02 |
| A6 = | −6.1284E−04 | −1.4464E−03 | 1.0388E−03 | 1.4004E−02 | −1.0552E−03 |
| A8 = | 2.2575E−05 | −1.0726E−04 | 4.1450E−05 | −6.3466E−03 | 2.2875E−05 |
| A10 = | | | | 4.0201E−04 | −1.0914E−03 |
| Surface # | 11 | 12 | 13 | 14 | 15 |
| k = | −9.7989E+00 | −6.0848E+01 | 3.5512E+01 | −6.0689E+00 | 8.9972E+01 |
| A4 = | −1.3780E−03 | 4.2593E−03 | −1.9967E−02 | −1.8112E−03 | −1.2668E−03 |
| A6 = | −1.2395E−03 | −2.1184E−04 | 4.4321E−03 | 1.6463E−04 | 4.6603E−05 |
| A8 = | 5.0792E−04 | 3.0494E−04 | −6.4069E−04 | 3.3974E−06 | 6.2184E−06 |
| A10 = | −8.1618E−05 | −5.5433E−05 | 9.3569E−05 | −8.2332E−07 | −9.7533E−07 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from TABLE 5 and TABLE 6 as the following values and satisfy the following conditions:

3rd Embodiment

| | | | |
|---|---|---|---|
| f (mm) | 2.74 | (R5 + R6)/(R5 − R6) | −0.71 |
| Fno | 2.80 | (R7 + R8)/(R7 − R8) | 0.25 |
| HFOV (deg.) | 79.9 | (R9 + R10)/(R9 − R10) | 0.61 |
| \|1/tan(HFOV)\| | 0.18 | R2/R4 | 1.08 |
| V7 | 55.9 | \|R10/R11\| | 0.34 |
| (V3 + V7)/2 | 43.95 | f/T67 | 1.99 |
| CT2/CT3 | 0.19 | (\|f1\| + \|f2\| + \|f3\| + \|f4\| + \|f5\|)/ | 1.11 |
| | | (\|f6\| + \|f7\|) | |
| CT6/CT3 | 0.27 | SD/TD | 0.43 |
| (CT4 + CT5 + CT6)/CT3 | 0.74 | Yc71/f | — |
| ΣCT/CT3 | 2.45 | Yc72/f | 1.03 |
| T45/T56 | 0.30 | Y11/Y72 | 1.30 |

Furthermore, in the optical imaging lens assembly according to the 3rd embodiment, when a focal length of the first lens element 310 is f1 a focal length of the second lens element 320 is f2, a focal length of the third lens element 330 is f3, a focal length of the fourth lens element 340 is f4, a focal length of the fifth lens element 350 is f5, a focal length of the sixth lens element 360 is f6, and a focal length of the seventh lens element 370 is f7, a minimum value among absolute values of f1, f2, f3, f4, f5, f6, and f7 is the absolute value of f5.

### 4th Embodiment

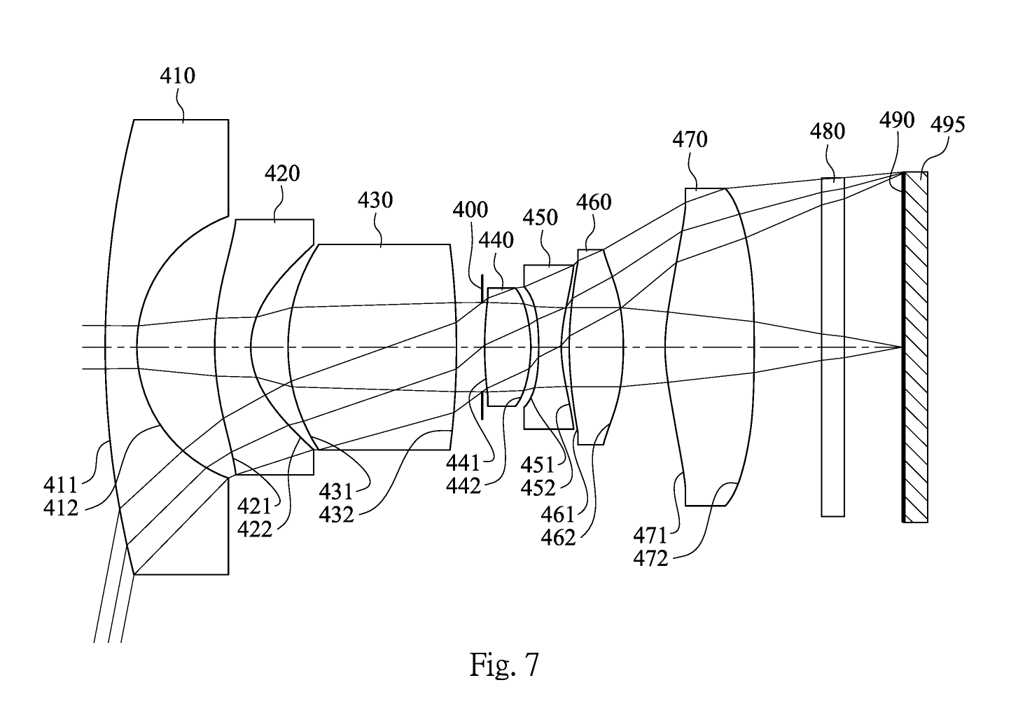

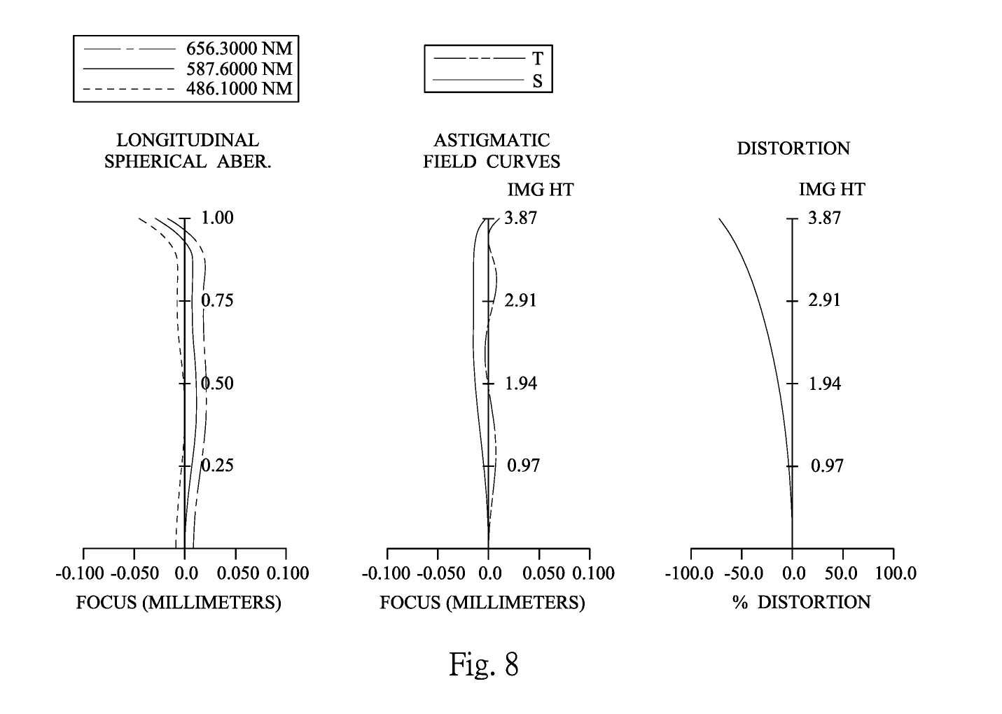

FIG. 7 is a schematic view of an image capturing apparatus according to the 4th embodiment of the present disclosure. FIG. 8 shows, in order from left to right, spherical aberration curves, astigmatic field curves and a distortion curve of the image capturing apparatus according to the 4th embodiment. In

FIG. 7, the image capturing apparatus includes the optical imaging lens assembly (its reference numeral is omitted) and an image sensor 495. The optical imaging lens assembly includes, in order from an object side to an image side, a first lens element 410, a second lens element 420, a third lens element 430, an aperture stop 400, a fourth lens element 440, a fifth lens element 450, a sixth lens element 460, a seventh lens element 470, a filter 480 and an image surface 490. The image sensor 495 is disposed on the image surface 490 of the optical imaging lens assembly. The optical imaging lens assembly has a total of seven lens elements (410-470). Moreover, there is an air gap between every two of the first lens element 410, the second lens element 420, the third lens element 430, the fourth lens element 440, the fifth lens element 450, the sixth lens element 460 and the seventh lens element 470 that are adjacent to each other.

The first lens element 410 with negative refractive power has an object-side surface 411 being convex in a paraxial region thereof and an image-side surface 412 being concave in a paraxial region thereof. The first lens element 410 is made of a glass material, and has the object-side surface 411 and the image-side surface 412 being both spherical.

The second lens element 420 with negative refractive power has an object-side surface 421 being convex in a paraxial region thereof and an image-side surface 422 being concave in a paraxial region thereof. The second lens element 420 is made of a plastic material, and has the object-side surface 421 and the image-side surface 422 being both aspheric.

The third lens element 430 with positive refractive power has an object-side surface 431 being convex in a paraxial region thereof and an image-side surface 432 being convex in a paraxial region thereof. The third lens element 430 is made of a glass material, and has the object-side surface 431 and the image-side surface 432 being both spherical.

The fourth lens element 440 with positive refractive power has an object-side surface 441 being convex in a paraxial region thereof and an image-side surface 442 being convex in a paraxial region thereof. The fourth lens element 440 is made of a plastic material, and has the object-side surface 441 and the image-side surface 442 being both aspheric.

The fifth lens element 450 with negative refractive power has an object-side surface 451 being concave in a paraxial region thereof and an image-side surface 452 being concave in a paraxial region thereof. The fifth lens element 450 is made of a plastic material, and has the object-side surface 451 and the image-side surface 452 being both aspheric.

The sixth lens element 460 with positive refractive power has an object-side surface 461 being convex in a paraxial region thereof and an image-side surface 462 being convex in a paraxial region thereof. The sixth lens element 460 is made of a plastic material, and has the object-side surface 461 and the image-side surface 462 being both aspheric.

The seventh lens element 470 with positive refractive power has an object-side surface 471 being convex in a paraxial region thereof and an image-side surface 472 being convex in a paraxial region thereof. The seventh lens element 470 is made of a plastic material, and has the object-side surface 471 and the image-side surface 472 being both aspheric. Furthermore, the object-side surface 471 of the seventh lens element 470 includes at least one concave shape in an off-axial region thereof, and the object-side surface 471 of the seventh lens element 470 includes at least one inflection point.

The filter 480 is made of a glass material and located between the seventh lens element 470 and the image surface 490, and will not affect the focal length of the optical imaging lens assembly.

The detailed optical data of the 4th embodiment are shown in TABLE 7 and the aspheric surface data are shown in TABLE 8 below.

TABLE 7
4th Embodiment
f = 2.69 mm, Fno = 2.80, HFOV = 79.2 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 20.242 | | 0.700 | Glass | 1.743 | 49.3 | −5.00 |
| 2 | | 3.092 | | 1.731 | | | | |
| 3 | Lens 2 | 6.110 | ASP | 0.799 | Plastic | 1.544 | 55.9 | −4.90 |
| 4 | | 1.769 | ASP | 0.828 | | | | |
| 5 | Lens 3 | 4.146 | | 3.740 | Glass | 1.904 | 31.3 | 4.05 |
| 6 | | −17.908 | | 0.570 | | | | |
| 7 | Ape. Stop | Plano | | 0.054 | | | | |
| 8 | Lens 4 | 8.778 | ASP | 1.025 | Plastic | 1.544 | 55.9 | 4.19 |
| 9 | | −2.949 | ASP | 0.175 | | | | |
| 10 | Lens 5 | −7.002 | ASP | 0.500 | Plastic | 1.639 | 23.5 | −3.03 |
| 11 | | 2.745 | ASP | 0.178 | | | | |
| 12 | Lens 6 | 7.415 | ASP | 1.201 | Plastic | 1.544 | 55.9 | 6.91 |
| 13 | | −7.175 | ASP | 0.926 | | | | |
| 14 | Lens 7 | 4.346 | ASP | 1.977 | Plastic | 1.544 | 55.9 | 7.46 |
| 15 | | −51.216 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.317 | | | | |
| 18 | Image | Plano | — | | | | |

Reference wavelength is 587.6 nm (d-line).

TABLE 8
Aspheric Coefficients

| | Surface # | | | | |
|---|---|---|---|---|---|
| | 3 | 4 | 8 | 9 | 10 |
| k = | −7.9377E−01 | −6.7547E−01 | −9.6519E+00 | −1.2117E+01 | 2.2475E+01 |
| A4 = | −9.9081E−04 | −4.2887E−03 | 7.4699E−03 | −2.8107E−02 | −4.3446E−02 |
| A6 = | −2.7960E−04 | −1.2042E−03 | 6.1470E−04 | −3.4734E−03 | 9.1959E−04 |
| A8 = | 3.3730E−06 | −2.0302E−04 | −3.2957E−03 | 5.0772E−03 | 7.9093E−03 |
| A10 = | −2.9241E−08 | 2.2455E−05 | | −5.2347E−03 | −4.8864E−03 |
| | Surface # | | | | |
| | 11 | 12 | 13 | 14 | 15 |
| k = | −1.0622E+01 | −7.2469E+01 | 8.2478E+00 | −9.3166E+00 | 8.9972E+01 |
| A4 = | −1.9264E−02 | 8.9245E−03 | −2.1153E−02 | −7.9090E−03 | −4.4986E−03 |
| A6 = | 6.7699E−03 | −4.4881E−03 | 7.1515E−03 | 1.0415E−03 | 4.4442E−05 |
| A8 = | −9.0585E−04 | 1.6935E−03 | −1.0955E−03 | −4.3793E−05 | 3.4845E−05 |
| A10 = | −4.1734E−05 | −2.3484E−04 | 1.2504E−04 | −5.2784E−07 | −2.4510E−06 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from TABLE 7 and TABLE 8 as the following values and satisfy the following conditions:

4th Embodiment

| | | | |
|---|---|---|---|
| f (mm) | 2.69 | (R5 + R6)/(R5 − R6) | −0.62 |
| Fno | 2.80 | (R7 + R8)/(R7 − R8) | 0.50 |
| HFOV (deg.) | 79.2 | (R9 + R10)/(R9 − R10) | 0.44 |
| \|1/tan(HFOV)\| | 0.19 | R2/R4 | 1.75 |
| V7 | 55.9 | \|R10/R11\| | 0.37 |
| (V3 + V7)/2 | 43.62 | f/T67 | 2.90 |
| CT2/CT3 | 0.21 | (\|f1\| + \|f2\| + \|f3\| + \|f4\| + \|f5\|)/ | 1.47 |
| | | (\|f6\| + \|f7\|) | |
| CT6/CT3 | 0.32 | SD/TD | 0.42 |
| (CT4 + CT5 + CT6)/CT3 | 0.73 | Yc71/f | 1.18 |
| ΣCT/CT3 | 2.66 | Yc72/f | — |
| T45/T56 | 0.98 | Y11/Y72 | 1.43 |

Furthermore, in the optical imaging lens assembly according to the 4th embodiment, when a focal length of the first lens element 410 is f1, a focal length of the second lens element 420 is f2, a focal length of the third lens element 430 is f3, a focal length of the fourth lens element 440 is f4, a focal length of the fifth lens element 450 is f5, a focal length of the sixth lens element 460 is f6, and a focal length of the seventh lens element 470 is f7, a minimum value among absolute values of f1, f2, f3, f4, f5, f6, and f7 is the absolute value of f5.

### 5th Embodiment

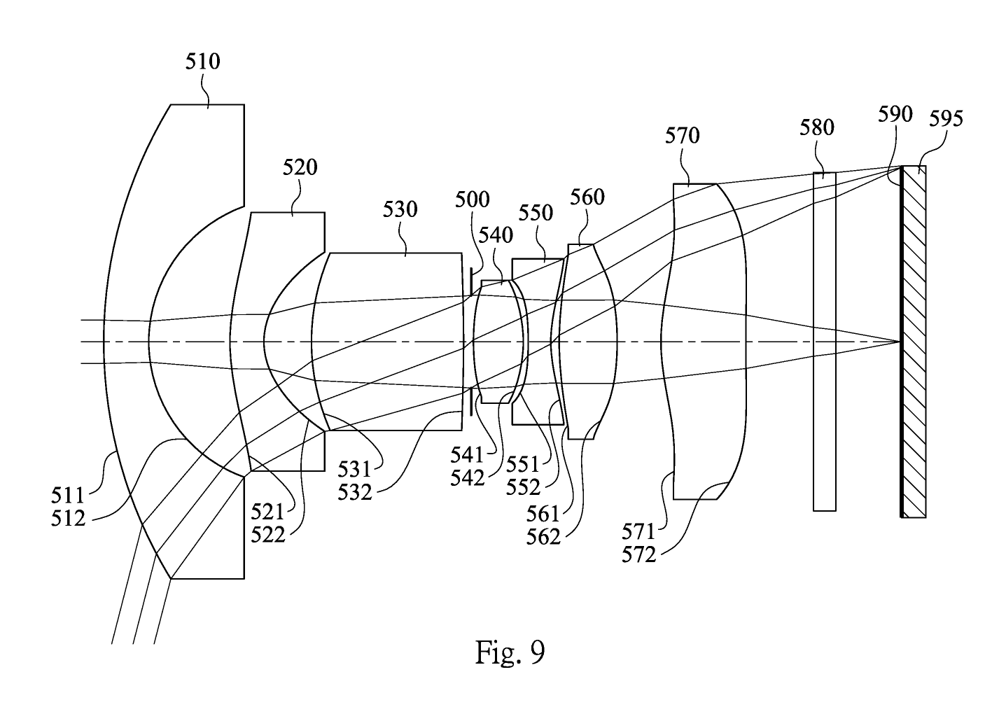

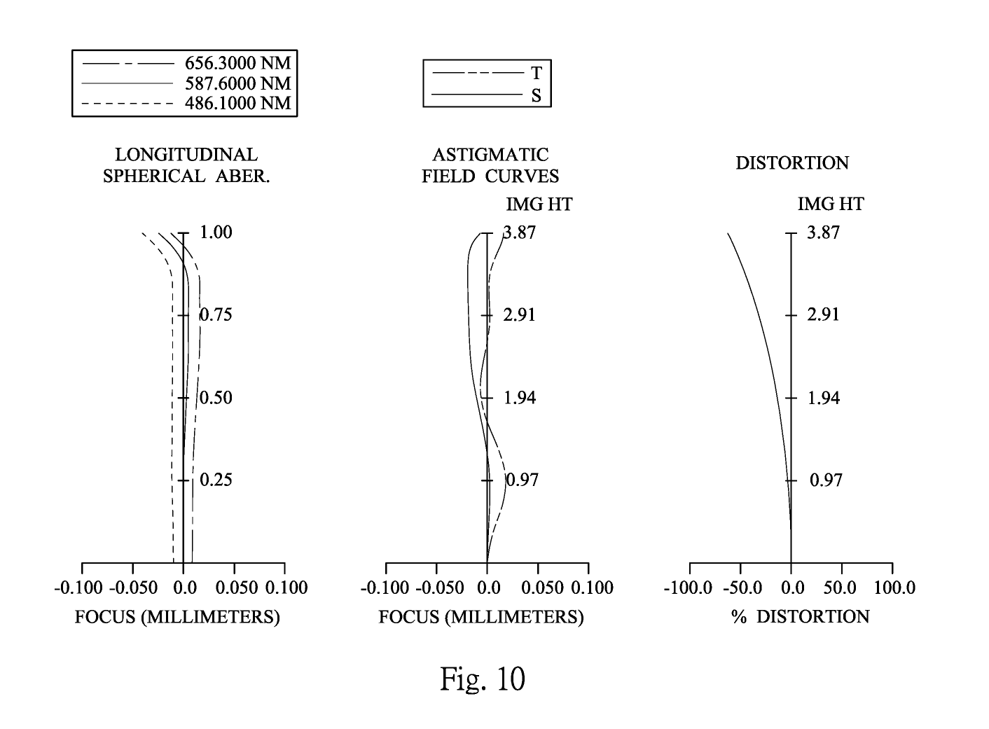

FIG. 9 is a schematic view of an image capturing apparatus according to the 5th embodiment of the present disclosure. FIG. 10 shows, in order from left to right, spherical aberration curves, astigmatic field curves and a distortion curve of the image capturing apparatus according to the 5th embodiment. In FIG. 9, the image capturing apparatus includes the optical imaging lens assembly (its reference numeral is omitted) and an image sensor 595. The optical imaging lens assembly includes, in order from an object side to an image side, a first lens element 510, a second lens element 520, a third lens element 530, an aperture stop 500, a fourth lens element 540, a fifth lens element 550, a sixth lens element 560, a seventh lens element 570, a filter 580 and an image surface 590. The image sensor 595 is disposed on the image surface 590 of the optical imaging lens assembly. The optical imaging lens assembly has a total of seven lens elements (510-570). Moreover, there is an air gap between every two of the first lens element 510, the second lens element 520, the third lens element 530, the fourth lens element 540, the fifth lens element 550, the sixth lens element 560 and the seventh lens element 570 that are adjacent to each other.

The first lens element 510 with negative refractive power has an object-side surface 511 being convex in a paraxial region thereof and an image-side surface 512 being concave in a paraxial region thereof. The first lens element 510 is made of a glass material, and has the object-side surface 511 and the image-side surface 512 being both spherical.

The second lens element 520 with negative refractive power has an object-side surface 521 being convex in a paraxial region thereof and an image-side surface 522 being concave in a paraxial region thereof. The second lens element 520 is made of a plastic material, and has the object-side surface 521 and the image-side surface 522 being both aspheric.

The third lens element 530 with positive refractive power has an object-side surface 531 being convex in a paraxial region thereof and an image-side surface 532 being convex in a paraxial region thereof. The third lens element 530 is made of a glass material, and has the object-side surface 531 and the image-side surface 532 being both spherical.

The fourth lens element 540 with positive refractive power has an object-side surface 541 being convex in a paraxial region thereof and an image-side surface 542 being convex in a paraxial region thereof. The fourth lens element 540 is made of a plastic material, and has the object-side surface 541 and the image-side surface 542 being both aspheric.

The fifth lens element 550 with negative refractive power has an object-side surface 551 being concave in a paraxial region thereof and an image-side surface 552 being concave in a paraxial region thereof. The fifth lens element 550 is made of a plastic material, and has the object-side surface 551 and the image-side surface 552 being both aspheric.

The sixth lens element 560 with positive refractive power has an object-side surface 561 being convex in a paraxial region thereof and an image-side surface 562 being convex in a paraxial region thereof. The sixth lens element 560 is made of a plastic material, and has the object-side surface 561 and the image-side surface 562 being both aspheric.

The seventh lens element 570 with positive refractive power has an object-side surface 571 being convex in a paraxial region thereof and an image-side surface 572 being concave in a paraxial region thereof. The seventh lens element 570 is made of a plastic material, and has the object-side surface 571 and the image-side surface 572 being both aspheric. Furthermore, the object-side surface 571 of the seventh lens element 570 includes at least one concave shape in an off-axial region thereof, and the object-side surface 571 and the image-side surface 572 of the seventh lens element 570 both include at least one inflection point.

The filter 580 is made of a glass material and located between the seventh lens element 570 and the image surface 590, and will not affect the focal length of the optical imaging lens assembly.

The detailed optical data of the 5th embodiment are shown in TABLE 9 and the aspheric surface data are shown in TABLE 10 below.

TABLE 9
5th Embodiment
f = 2.69 mm, Fno = 2.80, HFOV = 75.6 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 10.052 | | 1.000 | Glass | 1.804 | 46.5 | −6.22 |
| 2 | | 3.194 | | 1.803 | | | | |
| 3 | Lens 2 | 4.646 | ASP | 0.752 | Plastic | 1.544 | 55.9 | −4.51 |
| 4 | | 1.514 | ASP | 1.056 | | | | |
| 5 | Lens 3 | 4.876 | | 3.376 | Glass | 1.835 | 23.6 | 5.39 |
| 6 | | −39.805 | | 0.170 | | | | |
| 7 | Ape. Stop | Plano | | 0.050 | | | | |
| 8 | Lens 4 | 5.478 | ASP | 1.107 | Plastic | 1.544 | 55.9 | 3.52 |
| 9 | | −2.735 | ASP | 0.109 | | | | |
| 10 | Lens 5 | −7.855 | ASP | 0.500 | Plastic | 1.639 | 23.5 | −3.09 |
| 11 | | 2.702 | ASP | 0.188 | | | | |
| 12 | Lens 6 | 7.177 | ASP | 1.286 | Plastic | 1.544 | 55.9 | 6.78 |
| 13 | | −7.090 | ASP | 0.972 | | | | |
| 14 | Lens 7 | 4.180 | ASP | 1.884 | Plastic | 1.544 | 55.9 | 8.51 |
| 15 | | 36.272 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.460 | | | | |
| 18 | Image | Plano | — | | | | |

Reference wavelength is 587.6 nm (d-line).

TABLE 10
Aspheric Coefficients

| | Surface # | | | | |
|---|---|---|---|---|---|
| | 3 | 4 | 8 | 9 | 10 |
| k = | −8.3776E+00 | −5.6812E−01 | 1.2783E+01 | −9.3220E+00 | 2.8303E+01 |
| A4 = | −2.8534E−03 | −1.9241E−02 | 5.1155E−03 | −1.8392E−02 | −4.6920E−02 |
| A6 = | 3.2108E−04 | 3.1716E−05 | −1.5935E−04 | 4.7401E−03 | 1.1185E−02 |
| A8 = | −4.0506E−05 | −7.0681E−05 | −1.3972E−03 | −6.9049E−03 | −1.1462E−02 |
| A10 = | 1.8620E−06 | −7.3351E−05 | | 1.4089E−03 | 2.4664E−03 |
| | Surface # | | | | |
| | 11 | 12 | 13 | 14 | 15 |
| k = | −1.3526E+01 | −9.0000E+01 | 7.7110E+00 | −9.8375E+00 | 8.9972E+01 |
| A4 = | 6.5680E−04 | 1.4674E−02 | −2.3536E−02 | −4.6808E−03 | −3.9925E−03 |
| A6 = | −4.8362E−03 | −6.9693E−03 | 5.9960E−03 | −2.6604E−04 | −3.2673E−04 |
| A8 = | 1.8583E−03 | 1.9501E−03 | −1.2400E−03 | 4.2084E−05 | 2.5355E−05 |
| A10 = | −2.6909E−04 | −2.1913E−04 | 1.9091E−04 | −1.0158E−06 | −9.3890E−07 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from TABLE 9 and TABLE 10 as the following values and satisfy the following conditions:

5th Embodiment

| | | | |
|---|---|---|---|
| f (mm) | 2.69 | (R5 + R6)/(R5 − R6) | −0.78 |
| Fno | 2.80 | (R7 + R8)/(R7 − R8) | 0.33 |
| HFOV (deg.) | 75.6 | (R9 + R10)/(R9 − R10) | 0.49 |
| \|1/tan(HFOV)\| | 0.26 | R2/R4 | 2.11 |
| V7 | 55.9 | \|R10/R11\| | 0.38 |
| (V3 + V7)/2 | 39.79 | f/T67 | 2.76 |
| CT2/CT3 | 0.22 | (\|f1\| + \|f2\| + \|f3\| + \|f4\| + \|f5\|)/ | 1.49 |
| | | (\|f6\| + \|f7\|) | |
| CT6/CT3 | 0.38 | SD/TD | 0.43 |
| (CT4 + CT5 + CT6)/CT3 | 0.86 | Yc71/f | 0.95 |
| ΣCT/CT3 | 2.93 | Yc72/f | 0.47 |
| T45/T56 | 0.58 | Y11/Y72 | 1.50 |

Furthermore, in the optical imaging lens assembly according to the 5th embodiment, when a focal length of the first lens element 510 is f1, a focal length of the second lens element 520 is f2, a focal length of the third lens element 530 is f3, a focal length of the fourth lens element 540 is f4, a focal length of the fifth lens element 550 is f5, a focal length of the sixth lens element 560 is f6, and a focal length of the seventh lens element 570 is f7, a minimum value among absolute values of f1, f2, f3, f4, f5, f6, and f7 is the absolute value of f5.

### 6th Embodiment

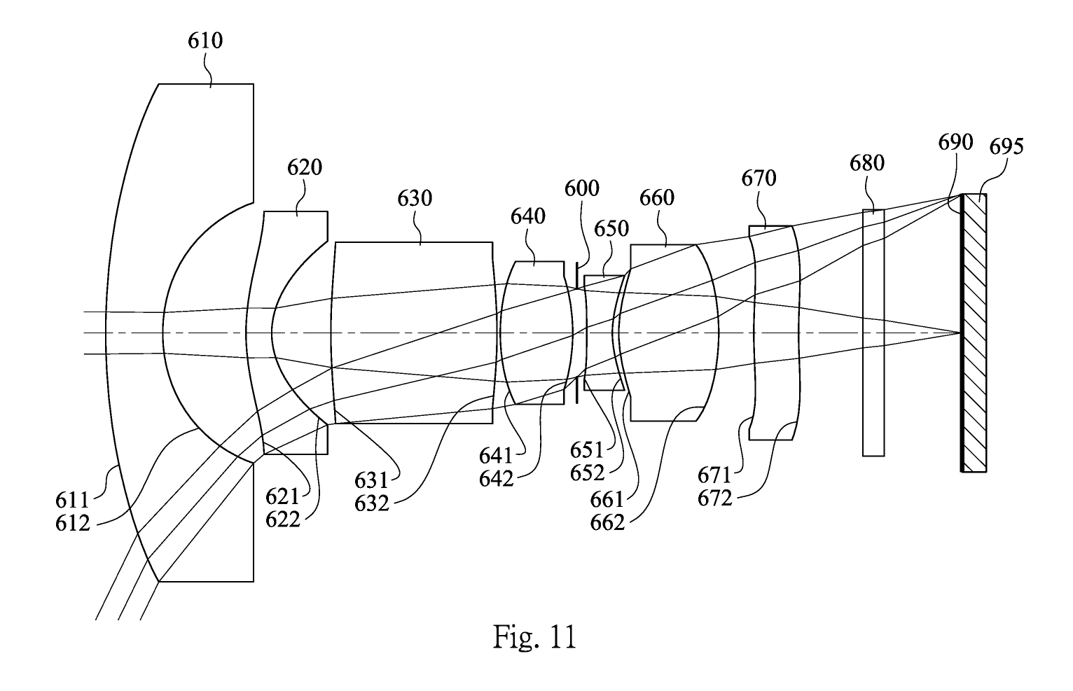

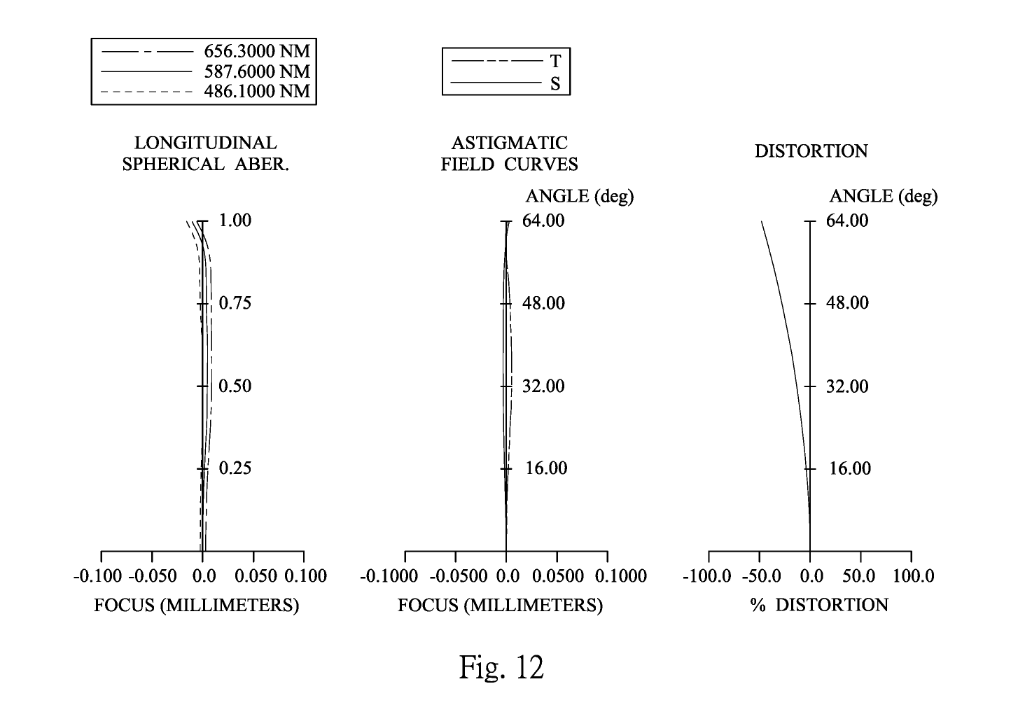

FIG. 11 is a schematic view of an image capturing apparatus according to the 6th embodiment of the present disclosure. FIG. 12 shows, in order from left to right, spherical aberration curves, astigmatic field curves and a distortion curve of the image capturing apparatus according to the 6th embodiment. In FIG. 11, the image capturing apparatus includes the optical imaging lens assembly (its reference numeral is omitted) and an image sensor 695. The optical imaging lens assembly includes, in order from an object side to an image side, a first lens element 610, a second lens element 620, a third lens element 630, a fourth lens element 640, an aperture stop 600, a fifth lens element 650, a sixth lens element 660, a seventh lens element 670, a filter 680 and an image surface 690. The image sensor 695 is disposed on the image surface 690 of the optical imaging lens assembly. The optical imaging lens assembly has a total of seven lens elements (610-670). Moreover, there is an air gap between every two of the first lens element 610, the second lens element 620, the third lens element 630, the fourth lens element 640, the fifth lens element 650, the sixth lens element 660 and the seventh lens element 670 that are adjacent to each other.

The first lens element 610 with negative refractive power has an object-side surface 611 being convex in a paraxial region thereof and an image-side surface 612 being concave in a paraxial region thereof. The first lens element 610 is made of a plastic material, and has the object-side surface 611 and the image-side surface 612 being both aspheric.

The second lens element 620 with negative refractive power has an object-side surface 621 being convex in a paraxial region thereof and an image-side surface 622 being concave in a paraxial region thereof. The second lens element 620 is made of a plastic material, and has the object-side surface 621 and the image-side surface 622 being both aspheric.

The third lens element 630 with positive refractive power has an object-side surface 631 being convex in a paraxial region thereof and an image-side surface 632 being convex in a paraxial region thereof. The third lens element 630 is made of a plastic material, and has the object-side surface 631 and the image-side surface 632 being both aspheric.

The fourth lens element 640 with positive refractive power has an object-side surface 641 being convex in a paraxial region thereof and an image-side surface 642 being convex in a paraxial region thereof. The fourth lens element 640 is made of a plastic material, and has the object-side surface 641 and the image-side surface 642 being both aspheric.

The fifth lens element 650 with negative refractive power has an object-side surface 651 being convex in a paraxial region thereof and an image-side surface 652 being concave in a paraxial region thereof. The fifth lens element 650 is made of a plastic material, and has the object-side surface 651 and the image-side surface 652 being both aspheric.

The sixth lens element 660 with positive refractive power has an object-side surface 661 being convex in a paraxial region thereof and an image-side surface 662 being convex in a paraxial region thereof. The sixth lens element 660 is made of a plastic material, and has the object-side surface 661 and the image-side surface 662 being both aspheric.

The seventh lens element 670 with positive refractive power has an object-side surface 671 being convex in a paraxial region thereof and an image-side surface 672 being concave in a paraxial region thereof. The seventh lens element 670 is made of a plastic material, and has the object-side surface 671 and the image-side surface 672 being both aspheric. Furthermore, the object-side surface 671 of the seventh lens element 670 includes at least one concave shape in an off-axial region thereof, and the object-side surface 671 and the image-side surface 672 of the seventh lens element 670 both include at least one inflection point.

The filter 680 is made of a glass material and located between the seventh lens element 670 and the image surface 690, and will not affect the focal length of the optical imaging lens assembly.

The detailed optical data of the 6th embodiment are shown in TABLE 11 and the aspheric surface data are shown in TABLE 12 below.

TABLE 11
6th Embodiment
f = 3.05 mm, Fno = 3.10, HFOV = 64.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 16.087 | ASP | 1.332 | Plastic | 1.515 | 56.5 | −9.47 |
| 2 | | 3.636 | ASP | 1.944 | | | | |
| 3 | Lens 2 | 4.953 | ASP | 0.600 | Plastic | 1.544 | 55.9 | −5.48 |
| 4 | | 1.781 | ASP | 1.382 | | | | |
| 5 | Lens 3 | 14.219 | ASP | 3.879 | Plastic | 1.660 | 20.4 | 11.47 |
| 6 | | −14.430 | ASP | 0.077 | | | | |
| 7 | Lens 4 | 4.577 | ASP | 1.693 | Plastic | 1.535 | 55.8 | 4.65 |
| 8 | | −4.744 | ASP | 0.100 | | | | |
| 9 | Ape. Stop | Plano | | 0.225 | | | | |
| 10 | Lens 5 | 50.584 | ASP | 0.600 | Plastic | 1.639 | 23.5 | −3.54 |
| 11 | | 2.155 | ASP | 0.151 | | | | |
| 12 | Lens 6 | 3.138 | ASP | 2.333 | Plastic | 1.535 | 55.8 | 4.16 |
| 13 | | −5.649 | ASP | 0.819 | | | | |
| 14 | Lens 7 | 10.235 | ASP | 1.049 | Plastic | 1.639 | 23.3 | 82.89 |
| 15 | | 12.182 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.819 | | | | |
| 18 | Image | Plano | — | | | | |

Reference wavelength is 587.6 nm (d-line).

TABLE 12
Aspheric Coefficients

| Surface # | 1 | 2 | 3 | 4 | 5 | 6 | 7 |
|---|---|---|---|---|---|---|---|
| k = | 4.5687E+00 | 3.0894E−01 | −1.2947E−01 | −4.9149E−01 | −6.1238E+01 | 7.0801E−01 | 2.7339E+00 |
| A4 = | 1.3212E−04 | 2.5457E−03 | −8.9150E−03 | −1.6304E−02 | −3.7165E−04 | −5.6181E−03 | −3.8659E−03 |
| A6 = | −1.7037E−05 | −8.7479E−06 | 9.8683E−04 | 8.2830E−04 | −9.8872E−05 | 3.3565E−03 | 2.9854E−03 |
| A8 = | 4.0634E−07 | −5.8983E−06 | −1.8468E−04 | 4.4855E−05 | 7.8828E−05 | −8.4537E−04 | −9.1421E−04 |
| A10 = | −3.7385E−09 | −4.1577E−07 | 1.4888E−05 | −7.7520E−05 | −1.6982E−05 | 1.3085E−04 | 1.3035E−04 |
| A12 = | | | −4.5932E−07 | | | | |
| Surface # | 8 | 10 | 11 | 12 | 13 | 14 | 15 |
| k = | −7.8759E+00 | −4.1845E+01 | −8.1199E+00 | −1.4905E+01 | −1.8019E+01 | −1.4467E+01 | −9.0000E+01 |
| A4 = | −1.7593E−02 | −7.2413E−02 | −3.3853E−03 | 2.3212E−02 | −2.1128E−02 | −1.8616E−02 | −1.1607E−02 |
| A6 = | 3.4362E−03 | 2.9184E−02 | 4.1928E−04 | −1.2476E−02 | 6.6208E−03 | 4.4762E−03 | 2.0202E−03 |
| A8 = | −6.8427E−04 | −1.1405E−02 | 2.5967E−03 | 5.0214E−03 | −2.1794E−03 | −1.0629E−03 | −4.3027E−04 |
| A10 = | 1.6323E−04 | 2.7626E−03 | −1.0819E−03 | −1.2774E−03 | 3.6381E−04 | 8.1321E−05 | 3.1633E−05 |
| A12 = | | | 1.0625E−04 | 8.5058E−05 | −3.1579E−05 | | |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from TABLE 11 and TABLE 12 as the following values and satisfy the following conditions:

6th Embodiment

| | | | |
|---|---|---|---|
| f (mm) | 3.05 | (R5 + R6)/(R5 − R6) | −0.01 |
| Fno | 3.10 | (R7 + R8)/(R7 − R8) | −0.02 |
| HFOV (deg.) | 64.0 | (R9 + R10)/(R9 − R10) | 1.09 |
| \|1/tan(HFOV)\| | 0.49 | R2/R4 | 2.04 |
| V7 | 23.3 | \|R10/R11\| | 0.69 |
| (V3 + V7)/2 | 21.84 | f/T67 | 3.73 |
| CT2/CT3 | 0.15 | (\|f1\| + \|f2\| + \|f3\| + \|f4\| + \|f5\|)/ | 0.40 |
| | | (\|f6\| + \|f7\|) | |
| CT6/CT3 | 0.60 | SD/TD | 0.32 |
| (CT4 + CT5 + CT6)/CT3 | 1.19 | Yc71/f | 0.44 |
| ΣCT/CT3 | 2.96 | Yc72/f | 0.43 |
| T45/T56 | 2.15 | Y11/Y72 | 2.33 |

Furthermore, in the optical imaging lens assembly according to the 6th embodiment, when a focal length of the first lens element 610 is f1, a focal length of the second lens element 620 is f2, a focal length of the third lens element 630 is f3, a focal length of the fourth lens element 640 is f4, a focal length of the fifth lens element 650 is f5, a focal length of the sixth lens element 660 is f6, and a focal length of the seventh lens element 670 is f7, a minimum value among absolute values of f1, f2, f3, f4, f5, f6, and f7 is the absolute value of f5.

### 7th Embodiment

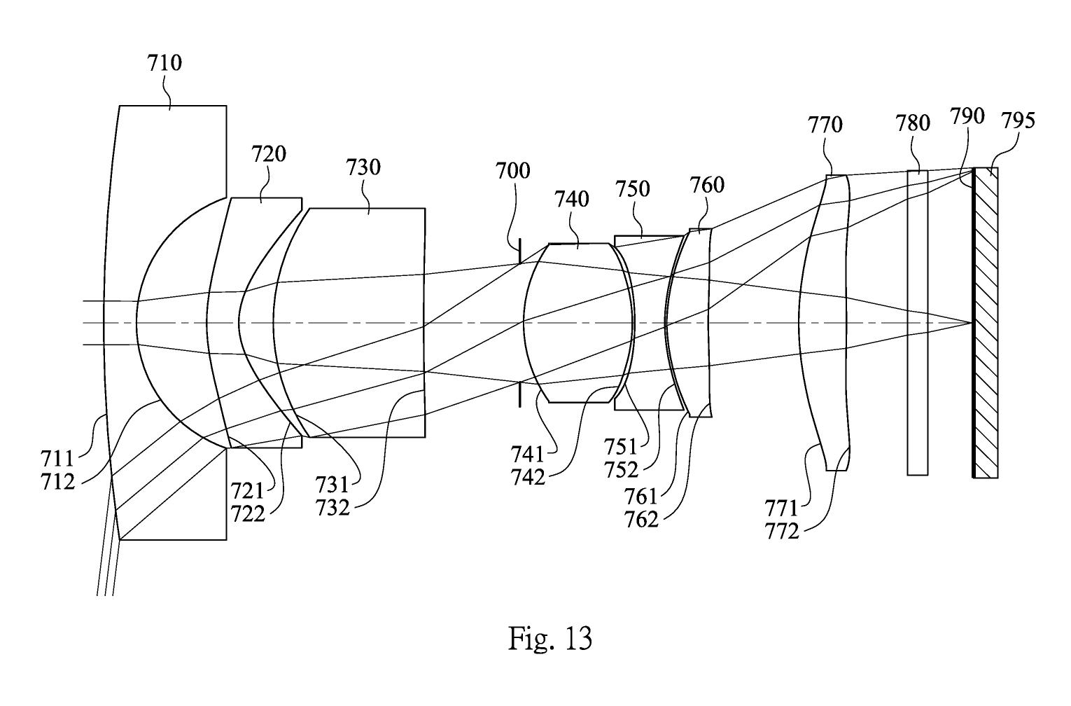

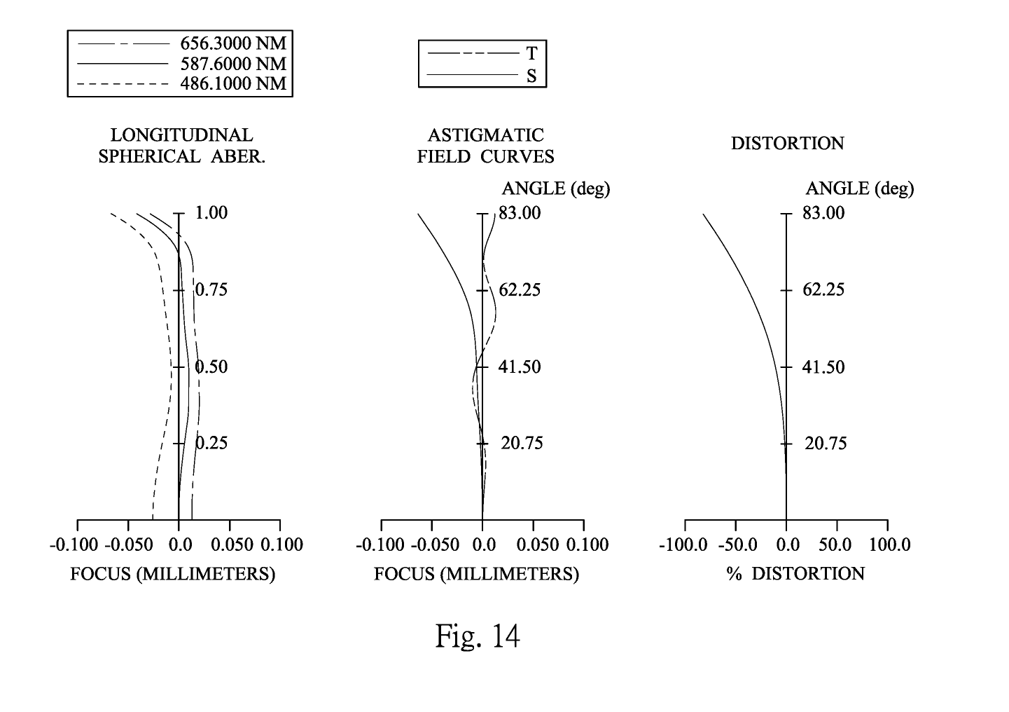

FIG. 13 is a schematic view of an image capturing apparatus according to the 7th embodiment of the present disclosure. FIG. 14 shows, in order from left to right, spherical aberration curves, astigmatic field curves and a distortion curve of the image capturing apparatus according to the 7th embodiment. In FIG. 13, the image capturing apparatus includes the optical imaging lens assembly (its reference numeral is omitted) and an image sensor 795. The optical imaging lens assembly includes, in order from an object side to an image side, a first lens element 710, a second lens element 720, a third lens element 730, an aperture stop 700, a fourth lens element 740, a fifth lens element 750, a sixth lens element 760, a seventh lens element 770, a filter 780 and an image surface 790. The image sensor 795 is disposed on the image surface 790 of the optical imaging lens assembly. The optical imaging lens assembly has a total of seven lens elements (710-770). Moreover, there is an air gap between every two of the first lens element 710, the second lens element 720, the third lens element 730, the fourth lens element 740, the fifth lens element 750, the sixth lens element 760 and the seventh lens element 770 that are adjacent to each other.

The first lens element 710 with negative refractive power has an object-side surface 711 being convex in a paraxial region thereof and an image-side surface 712 being concave in a paraxial region thereof. The first lens element 710 is made of a glass material, and has the object-side surface 711 and the image-side surface 712 being both spherical.

The second lens element 720 with negative refractive power has an object-side surface 721 being convex in a paraxial region thereof and an image-side surface 722 being concave in a paraxial region thereof. The second lens element 720 is made of a plastic material, and has the object-side surface 721 and the image-side surface 722 being both aspheric.

The third lens element 730 with positive refractive power has an object-side surface 731 being convex in a paraxial region thereof and an image-side surface 732 being concave in a paraxial region thereof. The third lens element 730 is made of a glass material, and has the object-side surface 731 and the image-side surface 732 being both spherical.

The fourth lens element 740 with positive refractive power has an object-side surface 741 being convex in a paraxial region thereof and an image-side surface 742 being convex in a paraxial region thereof. The fourth lens element 740 is made of a plastic material, and has the object-side surface 741 and the image-side surface 742 being both aspheric.

The fifth lens element 750 with negative refractive power has an object-side surface 751 being concave in a paraxial region thereof and an image-side surface 752 being concave in a paraxial region thereof. The fifth lens element 750 is made of a plastic material, and has the object-side surface 751 and the image-side surface 752 being both aspheric.

The sixth lens element 760 with positive refractive power has an object-side surface 761 being convex in a paraxial region thereof and an image-side surface 762 being concave in a paraxial region thereof. The sixth lens element 760 is made of a plastic material, and has the object-side surface 761 and the image-side surface 762 being both aspheric.

The seventh lens element 770 with positive refractive power has an object-side surface 771 being convex in a paraxial region thereof and an image-side surface 772 being convex in a paraxial region thereof. The seventh lens element 770 is made of a plastic material, and has the object-side surface 771 and the image-side surface 772 being both aspheric. Furthermore, the object-side surface 771 of the seventh lens element 770 includes at least one concave shape in an off-axial region thereof, and the object-side surface 771 and the image-side surface 772 of the seventh lens element 770 both include at least one inflection point.

The filter 780 is made of a glass material and located between the seventh lens element 770 and the image surface 790, and will not affect the focal length of the optical imaging lens assembly.

The detailed optical data of the 7th embodiment are shown in TABLE 13 and the aspheric surface data are shown in TABLE 14 below.

TABLE 13
7th Embodiment
f = 2.58 mm, Fno = 2.40, HFOV = 83.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 36.629 | | 0.800 | Glass | 1.804 | 46.5 | −4.48 |
| 2 | | 3.249 | | 1.732 | | | | |
| 3 | Lens 2 | 4.349 | ASP | 0.789 | Plastic | 1.544 | 55.9 | −6.09 |
| 4 | | 1.759 | ASP | 0.848 | | | | |
| 5 | Lens 3 | 4.862 | | 3.700 | Glass | 1.805 | 25.5 | 6.32 |
| 6 | | 71.429 | | 2.368 | | | | |
| 7 | Ape. Stop | Plano | | 0.090 | | | | |
| 8 | Lens 4 | 3.311 | ASP | 2.675 | Plastic | 1.535 | 55.8 | 3.86 |
| 9 | | −3.952 | ASP | 0.060 | | | | |
| 10 | Lens 5 | −7.240 | ASP | 0.738 | Plastic | 1.639 | 23.5 | −3.90 |
| 11 | | 3.953 | ASP | 0.050 | | | | |
| 12 | Lens 6 | 3.614 | ASP | 1.020 | Plastic | 1.544 | 55.9 | 9.07 |
| 13 | | 12.195 | ASP | 2.225 | | | | |
| 14 | Lens 7 | 7.137 | ASP | 1.174 | Plastic | 1.650 | 21.5 | 8.74 |
| 15 | | −26.071 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.129 | | | | |
| 18 | Image | Plano | — | | | | |

Reference wavelength is 587.6 nm (d-line).

TABLE 14
Aspheric Coefficients

| | Surface # | | | | |
|---|---|---|---|---|---|
| | 3 | 4 | 8 | 9 | 10 |
| k = | 5.8924E−01 | −9.0222E−01 | 6.2285E−01 | −1.0115E+00 | −8.3402E+01 |
| A4 = | −1.3093E−02 | −2.0573E−02 | −2.5778E−03 | −3.8778E−02 | −7.3629E−02 |
| A6 = | 7.5989E−04 | 1.3584E−03 | 1.2962E−04 | 3.5524E−02 | 4.1527E−02 |
| A8 = | −6.2163E−05 | −6.2765E−05 | −1.0297E−04 | −1.1289E−02 | −1.1956E−02 |
| A10 = | 3.5804E−06 | 1.1905E−06 | | 1.0995E−03 | 1.0453E−03 |
| A12 = | −1.8205E−07 | | | | |
| | Surface # | | | | |
| | 11 | 12 | 13 | 14 | 15 |
| k = | −1.9563E+00 | −1.7275E+01 | 2.5112E+01 | 4.0678E−01 | −8.9277E+01 |
| A4 = | −6.9357E−03 | 2.1764E−02 | −2.5462E−02 | −1.6710E−03 | 6.8307E−03 |
| A6 = | −4.8321E−03 | −1.5058E−02 | 7.8938E−03 | −6.1057E−05 | −6.9012E−04 |
| A8 = | 4.3811E−03 | 6.4704E−03 | −2.1383E−03 | 2.0475E−05 | 3.8397E−05 |
| A10 = | −1.1070E−03 | −1.2329E−03 | 3.9860E−04 | −1.3430E−06 | −1.4619E−06 |
| A12 = | 9.1122E−05 | 8.5058E−05 | −3.1579E−05 | | |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from TABLE 13 and TABLE 14 as the following values and satisfy the following conditions:

7th Embodiment

| | | | |
|---|---|---|---|
| f (mm) | 2.58 | (R5 + R6)/(R5 − R6) | −1.15 |
| Fno | 2.40 | (R7 + R8)/(R7 − R8) | −0.09 |
| HFOV (deg.) | 83.0 | (R9 + R10)/(R9 − R10) | 0.29 |
| \|1/tan(HFOV)\| | 0.12 | R2/R4 | 1.85 |
| V7 | 21.5 | \|R10/R11\| | 1.09 |
| (V3 + V7)/2 | 23.47 | f/T67 | 1.16 |
| CT2/CT3 | 0.21 | (\|f1\| + \|f2\| + \|f3\| + \|f4\| + \|f5\|)/ | 1.39 |
| | | (\|f6\| + \|f7\|) | |
| CT6/CT3 | 0.28 | SD/TD | 0.44 |
| (CT4 + CT5 + CT6)/CT3 | 1.20 | Yc71/f | — |
| ΣCT/CT3 | 2.94 | Yc72/f | 0.49 |
| T45/T56 | 1.20 | Y11/Y72 | 1.47 |

### 8th Embodiment

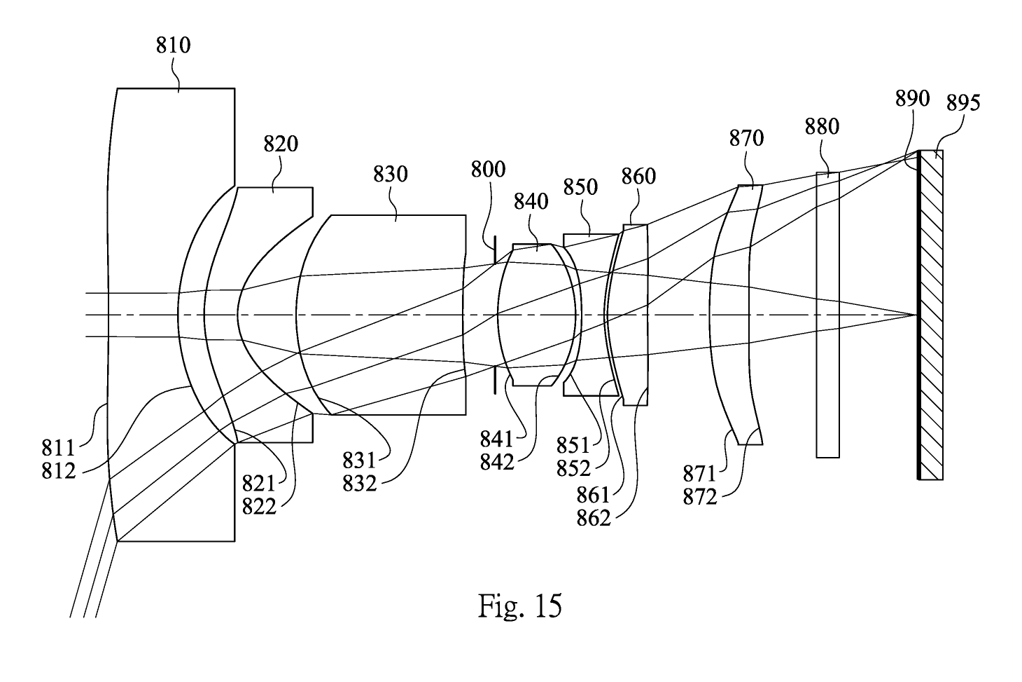

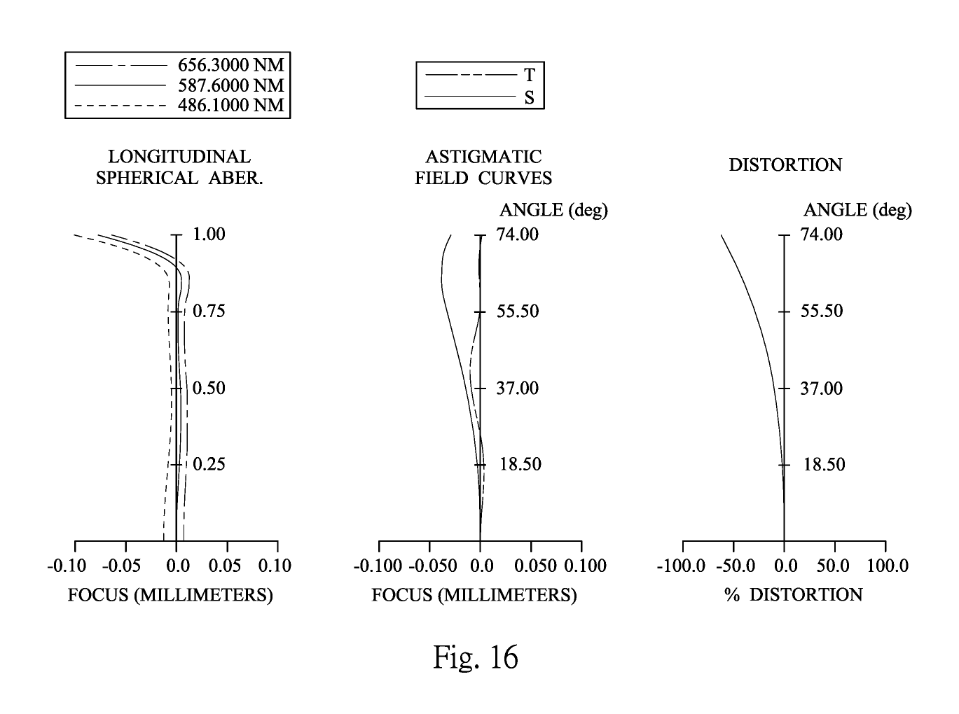

FIG. 15 is a schematic view of an image capturing apparatus according to the 8th embodiment of the present disclosure. FIG. 16 shows, in order from left to right, spherical aberration curves, astigmatic field curves and a distortion curve of the image capturing apparatus according to the 8th embodiment. In FIG. 15, the image capturing apparatus includes the optical imaging lens assembly (its reference numeral is omitted) and an image sensor 895. The optical imaging lens assembly includes, in order from an object side to an image side, a first lens element 810, a second lens element 820, a third lens element 830, an aperture stop 800, a fourth lens element 840, a fifth lens element 850, a sixth lens element 860, a seventh lens element 870, a filter 880 and an image surface 890. The image sensor 895 is disposed on the image surface 890 of the optical imaging lens assembly. The optical imaging lens assembly has a total of seven lens elements (810-870). Moreover, there is an air gap between every two of the first lens element 810, the second lens element 820, the third lens element 830, the fourth lens element 840, the fifth lens element 850, the sixth lens element 860 and the seventh lens element 870 that are adjacent to each other.

The first lens element 810 with negative refractive power has an object-side surface 811 being concave in a paraxial region thereof and an image-side surface 812 being concave in a paraxial region thereof. The first lens element 810 is made of a glass material, and has the object-side surface 811 and the image-side surface 812 being both aspheric.

The second lens element 820 with negative refractive power has an object-side surface 821 being convex in a paraxial region thereof and an image-side surface 822 being concave in a paraxial region thereof. The second lens element 820 is made of a plastic material, and has the object-side surface 821 and the image-side surface 822 being both aspheric.

The third lens element 830 with positive refractive power has an object-side surface 831 being convex in a paraxial region thereof and an image-side surface 832 being concave in a paraxial region thereof. The third lens element 830 is made of a plastic material, and has the object-side surface 831 and the image-side surface 832 being both aspheric.

The fourth lens element 840 with positive refractive power has an object-side surface 841 being convex in a paraxial region thereof and an image-side surface 842 being convex in a paraxial region thereof. The fourth lens element 840 is made of a plastic material, and has the object-side surface 841 and the image-side surface 842 being both aspheric.

The fifth lens element 850 with negative refractive power has an object-side surface 851 being concave in a paraxial region thereof and an image-side surface 852 being concave in a paraxial region thereof. The fifth lens element 850 is made of a plastic material, and has the object-side surface 851 and the image-side surface 852 being both aspheric.

The sixth lens element 860 with positive refractive power has an object-side surface 861 being convex in a paraxial region thereof and an image-side surface 862 being concave in a paraxial region thereof. The sixth lens element 860 is made of a plastic material, and has the object-side surface 861 and the image-side surface 862 being both aspheric.

The seventh lens element 870 with positive refractive power has an object-side surface 871 being convex in a paraxial region thereof and an image-side surface 872 being convex in a paraxial region thereof. The seventh lens element 870 is made of a plastic material, and has the object-side surface 871 and the image-side surface 872 being both aspheric. Furthermore, the object-side surface 871 of the seventh lens element 870 includes at least one concave shape in an off-axial region thereof, and the object-side surface 871 and the image-side surface 872 of the seventh lens element 870 both include at least one inflection point.

The filter 880 is made of a glass material and located between the seventh lens element 870 and the image surface 890, and will not affect the focal length of the optical imaging lens assembly.

The detailed optical data of the 8th embodiment are shown in TABLE 15 and the aspheric surface data are shown in TABLE 16 below.

TABLE 15
8th Embodiment
f = 2.79 mm, Fno = 2.90, HFOV = 74.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | −47.619 | ASP | 1.539 | Glass | 1.804 | 46.5 | −4.85 |
| 2 | | 4.306 | ASP | 0.584 | | | | |
| 3 | Lens 2 | 3.379 | ASP | 0.740 | Plastic | 1.544 | 55.9 | −5.47 |
| 4 | | 1.460 | ASP | 1.300 | | | | |
| 5 | Lens 3 | 4.013 | ASP | 3.700 | Plastic | 1.639 | 23.3 | 6.90 |
| 6 | | 28.628 | ASP | 0.721 | | | | |
| 7 | Ape. Stop | Plano | | 0.055 | | | | |
| 8 | Lens 4 | 3.408 | ASP | 1.729 | Plastic | 1.535 | 55.8 | 3.29 |
| 9 | | −2.990 | ASP | 0.134 | | | | |
| 10 | Lens 5 | −7.140 | ASP | 0.500 | Plastic | 1.639 | 23.5 | −3.48 |
| 11 | | 3.309 | ASP | 0.073 | | | | |
| 12 | Lens 6 | 3.147 | ASP | 0.889 | Plastic | 1.544 | 55.9 | 6.85 |
| 13 | | 18.319 | ASP | 1.375 | | | | |
| 14 | Lens 7 | 10.218 | ASP | 0.880 | Plastic | 1.650 | 21.5 | 12.65 |
| 15 | | −40.832 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.769 | | | | |
| 18 | Image | Plano | — | | | | |

Reference wavelength is 587.6 nm (d-line).

TABLE 16
Aspheric Coefficients

| Surface # | 1 | 2 | 3 | 4 | 5 | 6 | 8 |
|---|---|---|---|---|---|---|---|
| k = | −8.4853E+01 | 1.0753E−01 | 2.8662E−02 | −6.8167E−01 | 4.9304E−01 | 1.7996E+01 | 2.4263E+00 |
| A4 = | 9.9112E−04 | −2.7723E−05 | −5.6408E−03 | −4.4729E−03 | 9.8544E−04 | 5.4679E−03 | −4.5960E−03 |
| A6 = | −9.0794E−06 | 3.4016E−05 | −1.7748E−03 | −3.3303E−03 | 4.8718E−04 | 2.1366E−03 | 1.0856E−03 |
| A8 = | −3.2181E−07 | 1.8227E−05 | 2.0283E−04 | 4.3555E−04 | 6.3246E−05 | 3.5270E−05 | −1.4292E−03 |
| A10 = | 6.1717E−09 | 1.3188E−06 | −9.6563E−06 | −8.9230E−05 | −1.4278E−06 | 8.5160E−05 | |
| A12 = | | | −1.8205E−07 | | | | |

| Surface # | 9 | 10 | 11 | 12 | 13 | 14 | 15 |
|---|---|---|---|---|---|---|---|
| k = | −2.7737E−01 | −9.0000E+01 | −7.0105E+00 | −1.4901E+01 | 2.5585E+01 | 2.2368E+00 | 2.0945E+01 |
| A4 = | −4.1847E−02 | −8.9433E−02 | −8.3494E−03 | 1.3655E−02 | −2.0881E−02 | 8.0487E−03 | 1.2850E−02 |
| A6 = | 3.1332E−02 | 3.7140E−02 | −3.8082E−03 | −1.4403E−02 | 7.7431E−03 | −5.1683E−04 | −6.1459E−04 |
| A8 = | −1.2279E−02 | −1.2233E−02 | 4.3891E−03 | 6.7009E−03 | −2.3370E−03 | −3.9241E−06 | −3.8510E−05 |
| A10 = | 1.4902E−03 | 7.2270E−04 | −1.1513E−03 | −1.2933E−03 | 4.3122E−04 | −5.7298E−07 | 1.3725E−06 |
| A12 = | | | 9.1122E−05 | 8.5058E−05 | −3.1579E−05 | | |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from TABLE 15 and TABLE 16 as the following values and satisfy the following conditions:

8th Embodiment

| | | | |
|---|---|---|---|
| f (mm) | 2.79 | (R5 + R6)/(R5 − R6) | −1.33 |
| Fno | 2.90 | (R7 + R8)/(R7 − R8) | 0.07 |
| HFOV (deg.) | 74.0 | (R9 + R10)/(R9 − R10) | 0.37 |
| \|1/tan(HFOV)\| | 0.29 | R2/R4 | 2.95 |
| V7 | 21.5 | \|R10/R11\| | 1.05 |
| (V3 + V7)/2 | 22.38 | f/T67 | 2.03 |
| CT2/CT3 | 0.20 | (\|f1\| + \|f2\| + \|f3\| + \|f4\| + \|f5\|)/ | 1.23 |
| | | (\|f6\| + \|f7\|) | |
| CT6/CT3 | 0.24 | SD/TD | 0.40 |
| (CT4 + CT5 + CT6)/CT3 | 0.84 | Yc71/f | — |
| ΣCT/CT3 | 2.70 | Yc72/f | 0.25 |
| T45/T56 | 1.84 | Y11/Y72 | 1.74 |

### 9th Embodiment

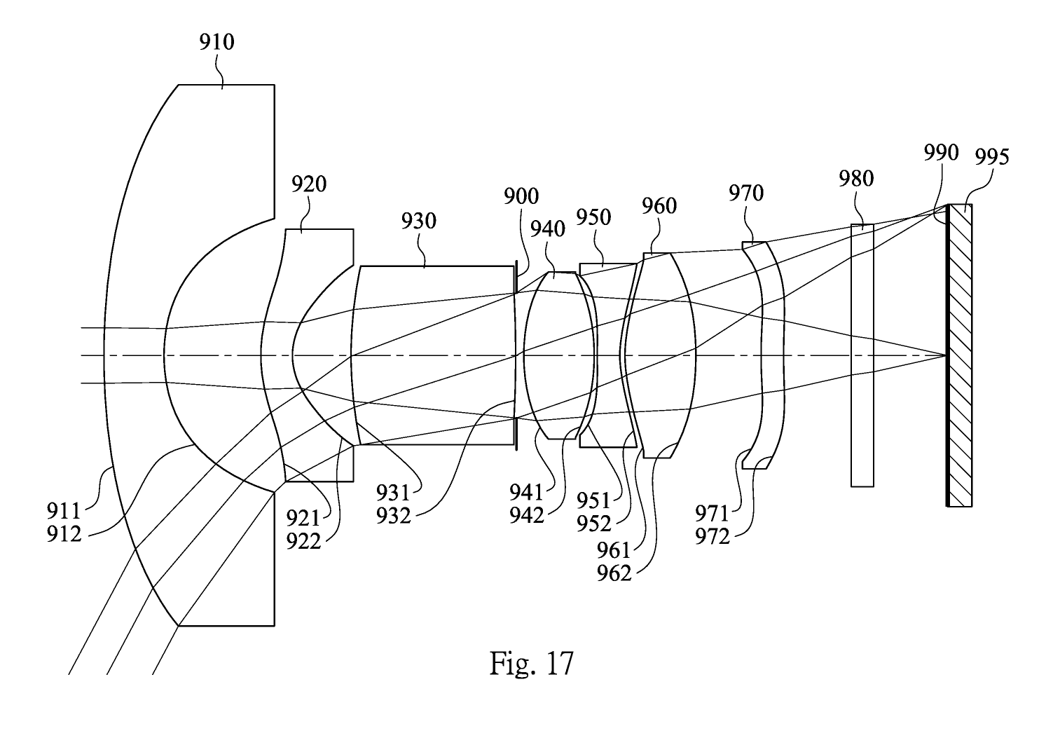

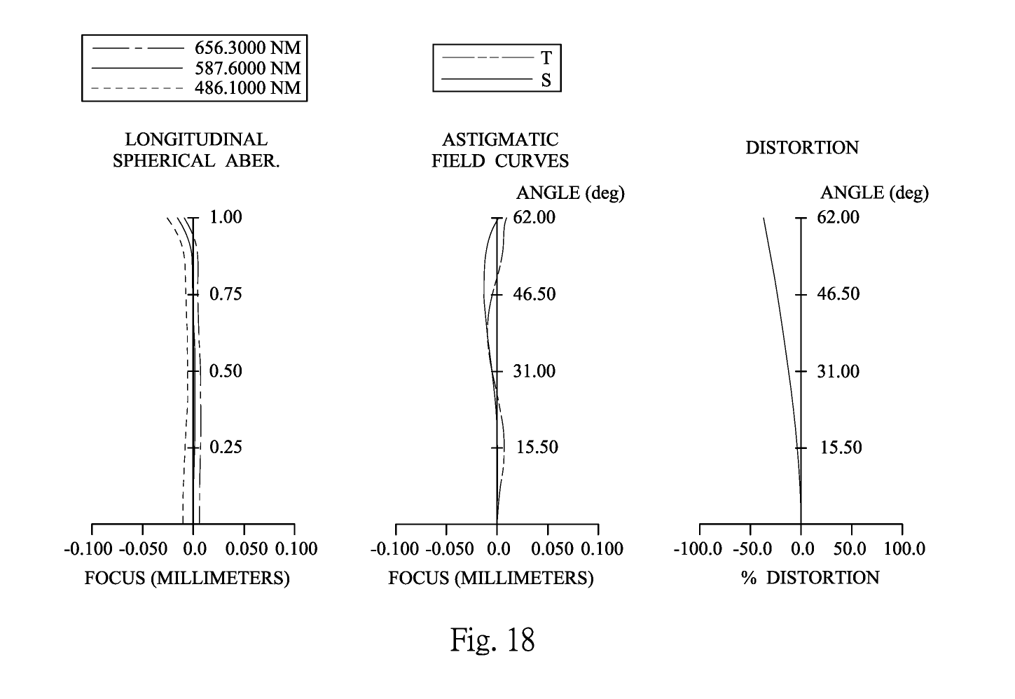

FIG. 17 is a schematic view of an image capturing apparatus according to the 9th embodiment of the present disclosure. FIG. 18 shows, in order from left to right, spherical aberration curves, astigmatic field curves and a distortion curve of the image capturing apparatus according to the 9th embodiment. In FIG. 17, the image capturing apparatus includes the optical imaging lens assembly (its reference numeral is omitted) and an image sensor 995. The optical imaging lens assembly includes, in order from an object side to an image side, a first lens element 910, a second lens element 920, a third lens element 930, an aperture stop 900, a fourth lens element 940, a fifth lens element 950, a sixth lens element 960, a seventh lens element 970, a filter 980 and an image surface 990. The image sensor 995 is disposed on the image surface 990 of the optical imaging lens assembly. The optical imaging lens assembly has a total of seven lens elements (910-970). Moreover, there is an air gap between every two of the first lens element 910, the second lens element 920, the third lens element 930, the fourth lens element 940, the fifth lens element 950, the sixth lens element 960 and the seventh lens element 970 that are adjacent to each other.

The first lens element 910 with negative refractive power has an object-side surface 911 being convex in a paraxial region thereof and an image-side surface 912 being concave in a paraxial region thereof. The first lens element 910 is made of a plastic material, and has the object-side surface 911 and the image-side surface 912 being both aspheric.

The second lens element 920 with negative refractive power has an object-side surface 921 being convex in a paraxial region thereof and an image-side surface 922 being concave in a paraxial region thereof. The second lens element 920 is made of a plastic material, and has the object-side surface 921 and the image-side surface 922 being both aspheric.

The third lens element 930 with positive refractive power has an object-side surface 931 being convex in a paraxial region thereof and an image-side surface 932 being convex in a paraxial region thereof. The third lens element 930 is made of a plastic material, and has the object-side surface 931 and the image-side surface 932 being both aspheric.

The fourth lens element 940 with positive refractive power has an object-side surface 941 being convex in a paraxial region thereof and an image-side surface 942 being convex in a paraxial region thereof. The fourth lens element 940 is made of a plastic material, and has the object-side surface 941 and the image-side surface 942 being both aspheric.

The fifth lens element 950 with negative refractive power has an object-side surface 951 being convex in a paraxial region thereof and an image-side surface 952 being concave in a paraxial region thereof. The fifth lens element 950 is made of a plastic material, and has the object-side surface 951 and the image-side surface 952 being both aspheric.

The sixth lens element 960 with positive refractive power has an object-side surface 961 being convex in a paraxial region thereof and an image-side surface 962 being convex in a paraxial region thereof. The sixth lens element 960 is made of a plastic material, and has the object-side surface 961 and the image-side surface 962 being both aspheric.

The seventh lens element 970 with positive refractive power has an object-side surface 971 being convex in a paraxial region thereof and an image-side surface 972 being concave in a paraxial region thereof. The seventh lens element 970 is made of a plastic material, and has the object-side surface 971 and the image-side surface 972 being both aspheric. Furthermore, the object-side surface 971 of the seventh lens element 970 includes at least one concave shape in an off-axial region thereof, and the object-side surface 971 and the image-side surface 972 of the seventh lens element 970 both include at least one inflection point.

The filter 980 is made of a glass material and located between the seventh lens element 970 and the image surface 990, and will not affect the focal length of the optical imaging lens assembly.

The detailed optical data of the 9th embodiment are shown in TABLE 17 and the aspheric surface data are shown in TABLE 18 below.

TABLE 17
9th Embodiment
f = 2.83 mm, Fno = 2.30, HFOV = 62.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 16.087 | ASP | 1.332 | Plastic | 1.515 | 56.5 | −9.47 |
| 2 | | 3.636 | ASP | 2.149 | | | | |
| 3 | Lens 2 | 3.396 | ASP | 0.700 | Plastic | 1.544 | 55.9 | −5.13 |
| 4 | | 1.420 | ASP | 1.300 | | | | |
| 5 | Lens 3 | 9.345 | ASP | 3.651 | Plastic | 1.660 | 20.4 | 11.49 |
| 6 | | −33.969 | ASP | 0.019 | | | | |
| 7 | Ape. Stop | Plano | | 0.161 | | | | |
| 8 | Lens 4 | 4.126 | ASP | 1.560 | Plastic | 1.535 | 55.8 | 4.85 |
| 9 | | −6.071 | ASP | 0.070 | | | | |
| 10 | Lens 5 | 18.424 | ASP | 0.500 | Plastic | 1.639 | 23.5 | −4.34 |
| 11 | | 2.384 | ASP | 0.115 | | | | |
| 12 | Lens 6 | 2.900 | ASP | 1.572 | Plastic | 1.535 | 55.8 | 4.02 |
| 13 | | −6.759 | ASP | 1.448 | | | | |
| 14 | Lens 7 | 9.080 | ASP | 0.498 | Plastic | 1.639 | 23.3 | 57.89 |
| 15 | | 11.778 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.642 | | | | |
| 18 | Image | Plano | — | | | | |

Reference wavelength is 587.6 nm (d-line).

TABLE 18
Aspheric Coefficients

| Surface # | 1 | 2 | 3 | 4 | 5 | 6 | 8 |
|---|---|---|---|---|---|---|---|
| k = | 4.5687E+00 | 3.0894E−01 | −1.2102E+00 | −6.2595E−01 | −8.8236E−01 | 5.7484E+01 | 2.7882E+00 |
| A4 = | 3.6438E−04 | 5.6928E−03 | 1.2355E−03 | −7.8373E−03 | 9.0518E−04 | −3.9756E−03 | −3.9950E−03 |
| A6 = | −1.7037E−05 | −3.7919E−05 | −5.1149E−03 | −1.3117E−02 | −2.5412E−04 | 1.6136E−03 | 1.1934E−03 |
| A8 = | 4.0634E−07 | 1.0291E−05 | 8.6332E−04 | 2.4119E−03 | −5.3165E−05 | −4.5361E−04 | −8.9203E−05 |
| A10 = | −3.7385E−09 | −4.6062E−07 | −6.1833E−05 | −1.6771E−04 | 2.0090E−05 | 6.2917E−05 | |
| A12 = | | | 1.6912E−06 | | | | |
| Surface # | 9 | 10 | 11 | 12 | 13 | 14 | 15 |
| k = | 6.3085E+00 | −4.1845E+01 | −1.0633E+01 | −1.6201E+01 | −3.5823E+01 | −2.1438E+01 | −9.0000E+01 |
| A4 = | −4.3827E−02 | −8.6915E−02 | −7.6827E−03 | 1.1166E−02 | −2.7371E−02 | −2.5888E−02 | −1.8571E−02 |
| A6 = | 2.2645E−02 | 2.7750E−02 | −4.9509E−03 | −1.1049E−02 | 7.5409E−03 | 1.9775E−03 | 1.1252E−03 |
| A8 = | −4.0668E−03 | −4.2554E−03 | 5.5559E−03 | 5.4540E−03 | −2.1923E−03 | −4.6536E−04 | −1.7938E−04 |
| A10 = | 1.9595E−04 | −1.9888E−04 | −1.6700E−03 | −1.1561E−03 | 4.1244E−04 | 4.5998E−05 | 1.8986E−05 |
| A12 = | | | 1.6071E−04 | 8.5058E−05 | −3.1579E−05 | | |

In the 9th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 9th embodiment, so an explanation in this regard will not be provided again.

Moreover, these parameters can be calculated from TABLE 17 and TABLE 18 as the following values and satisfy the following conditions:

9th Embodiment

| | | | |
|---|---|---|---|
| f (mm) | 2.83 | (R5 + R6)/(R5 − R6) | −0.57 |
| Fno | 2.30 | (R7 + R8)/(R7 − R8) | −0.19 |
| HFOV (deg.) | 62.0 | (R9 + R10)/(R9 − R10) | 1.30 |
| \|1/tan(HFOV)\| | 0.53 | R2/R4 | 2.56 |
| V7 | 23.3 | \|R10/R11\| | 0.82 |
| (V3 + V7)/2 | 21.84 | f/T67 | 1.95 |
| CT2/CT3 | 0.19 | (\|f1\| + \|f2\| + \|f3\| + \|f4\| + \|f5\|)/ | 0.57 |
| | | (\|f6\| + \|f7\|) | |
| CT6/CT3 | 0.43 | SD/TD | 0.39 |
| (CT4 + CT5 + CT6)/CT3 | 0.99 | Yc71/f | 0.36 |
| ΣCT/CT3 | 2.69 | Yc72/f | 0.35 |
| T45/T56 | 0.61 | Y11/Y72 | 2.38 |

### 10th Embodiment

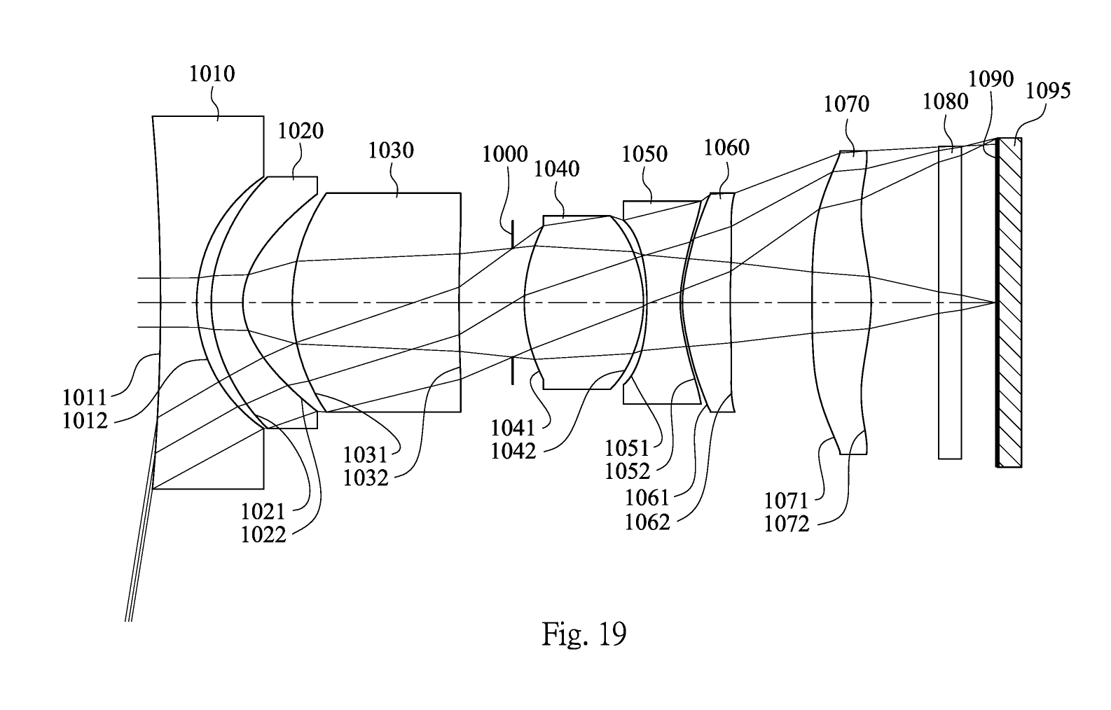

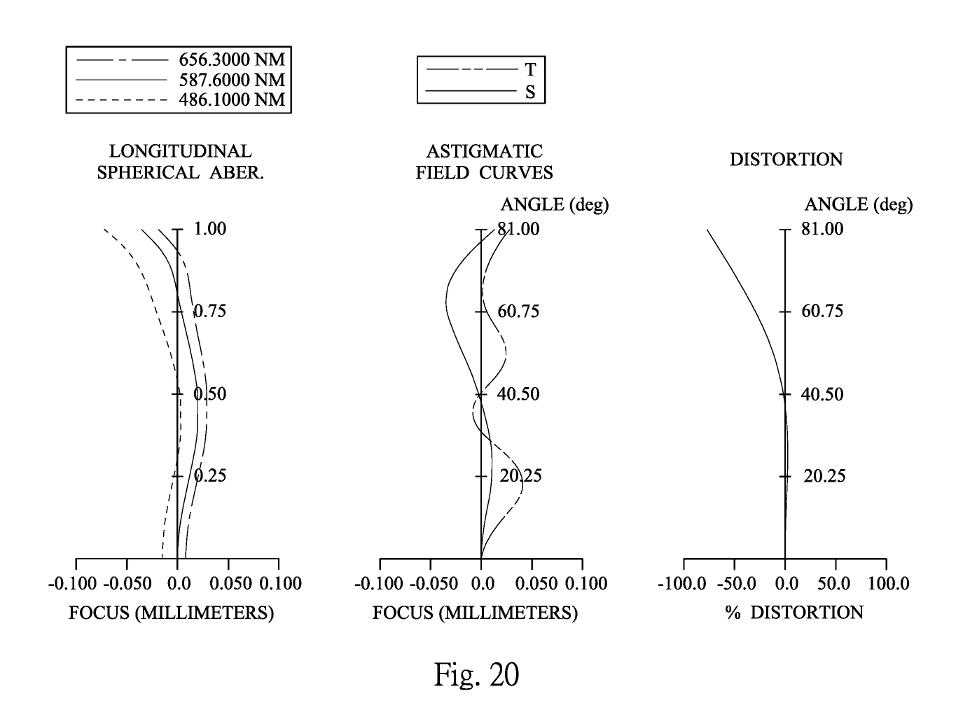

FIG. 19 is a schematic view of an image capturing apparatus according to the 10th embodiment of the present disclosure. FIG. 20 shows, in order from left to right, spherical aberration curves, astigmatic field curves and a distortion curve of the image capturing apparatus according to the 10th embodiment. In FIG. 19, the image capturing apparatus includes the optical imaging lens assembly (its reference numeral is omitted) and an image sensor 1095. The optical imaging lens assembly includes, in order from an object side to an image side, a first lens element 1010, a second lens element 1020, a third lens element 1030, an aperture stop 1000, a fourth lens element 1040, a fifth lens element 1050, a sixth lens element 1060, a seventh lens element 1070, a filter 1080 and an image surface 1090. The image sensor 1095 is disposed on the image surface 1090 of the optical imaging lens assembly. The optical imaging lens assembly has a total of seven lens elements (1010-1070). Moreover, there is an air gap between every two of the first lens element 1010, the second lens element 1020, the third lens element 1030, the fourth lens element 1040, the fifth lens element 1050, the sixth lens element 1060 and the seventh lens element 1070 that are adjacent to each other.

The first lens element 1010 with negative refractive power has an object-side surface 1011 being concave in a paraxial region thereof and an image-side surface 1012 being concave in a paraxial region thereof. The first lens element 1010 is made of a glass material, and has the object-side surface 1011 and the image-side surface 1012 being both spherical.

The second lens element 1020 with negative refractive power has an object-side surface 1021 being convex in a paraxial region thereof and an image-side surface 1022 being concave in a paraxial region thereof. The second lens element 1020 is made of a plastic material, and has the object-side surface 1021 and the image-side surface 1022 being both aspheric.

The third lens element 1030 with positive refractive power has an object-side surface 1031 being convex in a paraxial region thereof and an image-side surface 1032 being concave in a paraxial region thereof. The third lens element 1030 is made of a glass material, and has the object-side surface 1031 and the image-side surface 1032 being both spherical.

The fourth lens element 1040 with positive refractive power has an object-side surface 1041 being convex in a paraxial region thereof and an image-side surface 1042 being convex in a paraxial region thereof. The fourth lens element 1040 is made of a plastic material, and has the object-side surface 1041 and the image-side surface 1042 being both aspheric.

The fifth lens element 1050 with negative refractive power has an object-side surface 1051 being concave in a paraxial region thereof and an image-side surface 1052 being concave in a paraxial region thereof. The fifth lens element 1050 is made of a plastic material, and has the object-side surface 1051 and the image-side surface 1052 being both aspheric.

The sixth lens element 1060 with positive refractive power has an object-side surface 1061 being convex in a paraxial region thereof and an image-side surface 1062 being concave in a paraxial region thereof. The sixth lens element 1060 is made of a plastic material, and has the object-side surface 1061 and the image-side surface 1062 being both aspheric.

The seventh lens element 1070 with positive refractive power has an object-side surface 1071 being convex in a paraxial region thereof and an image-side surface 1072 being convex in a paraxial region thereof. The seventh lens element 1070 is made of a plastic material, and has the object-side surface 1071 and the image-side surface 1072 being both aspheric. Furthermore, the object-side surface 1071 of the seventh lens element 1070 includes at least one concave shape in an off-axial region thereof, and the object-side surface 1071 and the image-side surface 1072 of the seventh lens element 1070 both include at least one inflection point.

The filter 1080 is made of a glass material and located between the seventh lens element 1070 and the image surface 1090, and will not affect the focal length of the optical imaging lens assembly.

The detailed optical data of the 10th embodiment are shown in TABLE 19 and the aspheric surface data are shown in TABLE 20 below.

TABLE 19
10th Embodiment
f = 2.53 mm, Fno = 2.32, HFOV = 81.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | −47.619 | | 0.800 | Glass | 1.804 | 46.5 | −3.88 |
| 2 | | 3.368 | | 0.325 | | | | |
| 3 | Lens 2 | 3.325 | ASP | 0.700 | Plastic | 1.544 | 55.9 | −6.45 |
| 4 | | 1.580 | ASP | 1.096 | | | | |
| 5 | Lens 3 | 4.275 | | 3.700 | Glass | 1.805 | 25.5 | 5.70 |
| 6 | | 38.462 | | 1.190 | | | | |
| 7 | Ape. Stop | Plano | | 0.259 | | | | |
| 8 | Lens 4 | 3.501 | ASP | 2.642 | Plastic | 1.535 | 55.8 | 3.54 |
| 9 | | −3.041 | ASP | 0.076 | | | | |
| 10 | Lens 5 | −7.405 | ASP | 0.741 | Plastic | 1.639 | 23.5 | −3.21 |
| 11 | | 2.944 | ASP | 0.050 | | | | |
| 12 | Lens 6 | 2.760 | ASP | 1.057 | Plastic | 1.544 | 55.9 | 6.31 |
| 13 | | 12.195 | ASP | 1.817 | | | | |
| 14 | Lens 7 | 58.824 | ASP | 1.311 | Plastic | 1.650 | 21.5 | 6.01 |
| 15 | | −4.153 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 0.800 | | | | |
| 18 | Image | Plano | — | | | | |

Reference wavelength is 587.6 nm (d-line).

TABLE 20
Aspheric Coefficients

| | Surface # | | | | |
|---|---|---|---|---|---|
| | 3 | 4 | 8 | 9 | 10 |
| k = | 1.3860E−01 | −6.8517E−01 | 1.6637E+00 | −9.7204E−01 | −9.0000E+01 |
| A4 = | −1.3315E−04 | −1.3876E−02 | −6.6598E−03 | −3.8014E−02 | −7.9122E−02 |
| A6 = | −1.7765E−03 | −2.8121E−03 | −7.2293E−04 | 3.3191E−02 | 4.0998E−02 |
| A8 = | 2.4119E−04 | 5.3908E−04 | −2.8949E−04 | −1.1268E−02 | −1.1668E−02 |
| A10 = | −1.2910E−05 | −5.6166E−05 | | 1.1927E−03 | 9.9475E−04 |
| A12 = | −1.8205E−07 | | | | |
| | Surface # | | | | |
| | 11 | 12 | 13 | 14 | 15 |
| k = | −7.2379E+00 | −1.2510E+01 | 2.3125E+01 | 9.0000E+01 | −7.1194E−01 |
| A4 = | −7.6516E−03 | 1.3553E−02 | −2.5569E−02 | 8.0804E−03 | 1.9402E−02 |
| A6 = | −3.8801E−03 | −1.4708E−02 | 8.0145E−03 | −3.3980E−04 | −5.3798E−04 |
| A8 = | 4.3209E−03 | 6.7610E−03 | −2.3234E−03 | 1.0639E−05 | −3.3172E−05 |
| A10 = | −1.1292E−03 | −1.2740E−03 | 4.3257E−04 | −1.0142E−06 | 9.1931E−07 |
| A12 = | 9.1122E−05 | 8.5058E−05 | −3.1579E−05 | | |

In the 10th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 10th embodiment, so an explanation in this regard will not be provided again.

Moreover, these parameters can be calculated from TABLE 19 and TABLE 20 as the following values and satisfy the following conditions:

10th Embodiment

| | | | |
|---|---|---|---|
| f (mm) | 2.53 | (R5 + R6)/(R5 − R6) | −1.25 |
| Fno | 2.32 | (R7 + R8)/(R7 − R8) | 0.07 |
| HFOV (deg.) | 81.0 | (R9 + R10)/(R9 − R10) | 0.43 |
| \|1/tan(HFOV)\| | 0.16 | R2/R4 | 2.13 |
| V7 | 21.5 | \|R10/R11\| | 1.07 |
| (V3 + V7)/2 | 23.47 | f/T67 | 1.39 |
| CT2/CT3 | 0.19 | (\|f1\| + \|f2\| + \|f3\| + \|f4\| + \|f5\|)/ | 1.85 |
| | | (\|f6\| + \|f7\|) | |
| CT6/CT3 | 0.29 | SD/TD | 0.50 |
| (CT4 + CT5 + CT6)/CT3 | 1.20 | Yc71/f | — |
| ΣCT/CT3 | 2.96 | Yc72/f | 0.80 |
| T45/T56 | 1.52 | Y11/Y72 | 1.23 |

Furthermore, in the optical imaging lens assembly according to the 10th embodiment, when a focal length of the first lens element 1010 is f1, a focal length of the second lens element 1020 is f2, a focal length of the third lens element 1030 is f3, a focal length of the fourth lens element 1040 is f4, a focal length of the fifth lens element 1050 is f5, a focal length of the sixth lens element 1060 is f6, and a focal length of the seventh lens element 1070 is f7, a minimum value among absolute values of f1, f2, f3, f4, f5, f6, and f7 is the absolute value of f5.

### 11th Embodiment

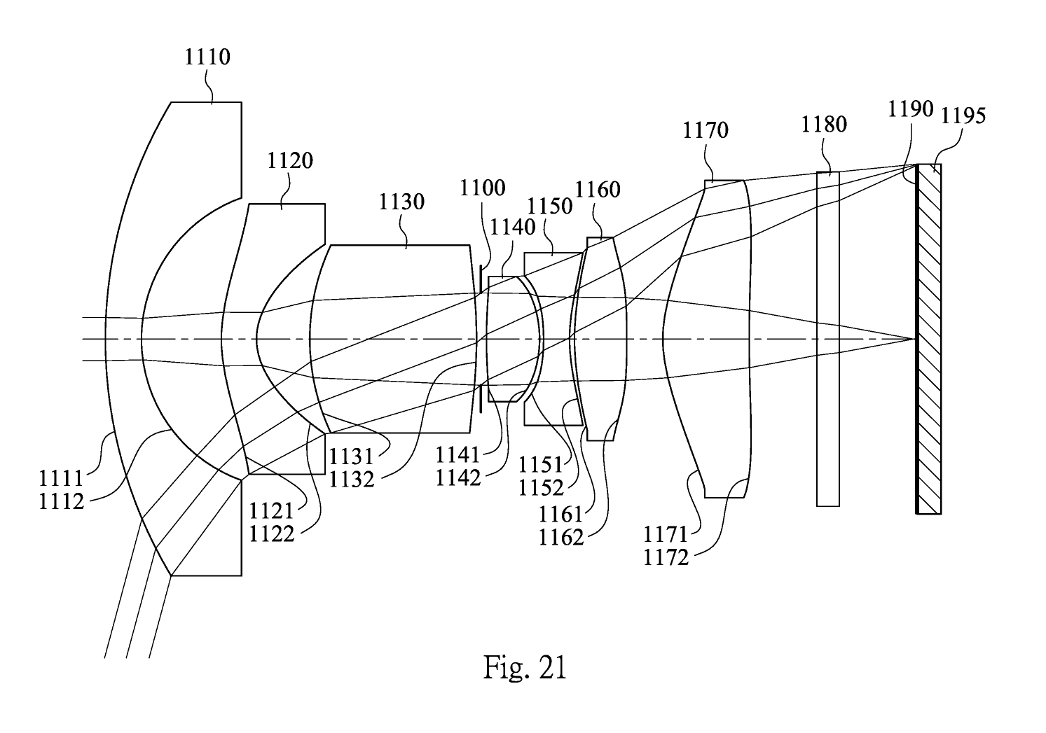

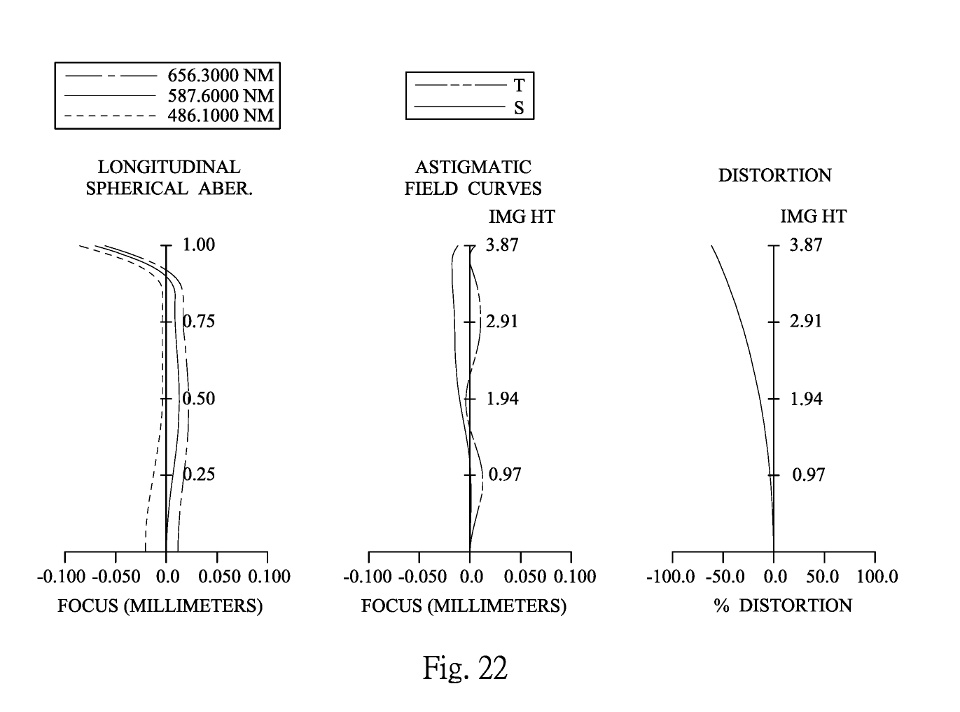

FIG. 21 is a schematic view of an image capturing apparatus according to the 11th embodiment of the present disclosure. FIG. 22 shows, in order from left to right, spherical aberration curves, astigmatic field curves and a distortion curve of the image capturing apparatus according to the 11th embodiment. In FIG. 21, the image capturing apparatus includes the optical imaging lens assembly (its reference numeral is omitted) and an image sensor 1195. The optical imaging lens assembly includes, in order from an object side to an image side, a first lens element 1110, a second lens element 1120, a third lens element 1130, an aperture stop 1100, a fourth lens element 1140, a fifth lens to element 1150, a sixth lens element 1160, a seventh lens element 1170, a filter 1180 and an image surface 1190. The image sensor 1195 is disposed on the image surface 1190 of the optical imaging lens assembly. The optical imaging lens assembly has a total of seven lens elements (1110-1170). Moreover, there is an air gap between every two of the first lens element 1110, the second lens element 1120, the third lens element 1130, the fourth lens element 1140, the fifth lens element 1150, the sixth lens element 1160 and the seventh lens element 1170 that are adjacent to each other.

The first lens element 1110 with negative refractive power has an object-side surface 1111 being convex in a paraxial region thereof and an image-side surface 1112 being concave in a paraxial region thereof. The first lens element 1110 is made of a glass material, and has the object-side surface 1111 and the image-side surface 1112 being both spherical.

The second lens element 1120 with negative refractive power has an object-side surface 1121 being convex in a paraxial region thereof and an image-side surface 1122 being concave in a paraxial region thereof. The second lens element 1120 is made of a plastic material, and has the object-side surface 1121 and the image-side surface 1122 being both aspheric.

The third lens element 1130 with positive refractive power has an object-side surface 1131 being convex in a paraxial region thereof and an image-side surface 1132 being convex in a paraxial region thereof. The third lens element 1130 is made of a glass material, and has the object-side surface 1131 and the image-side surface 1132 being both spherical.

The fourth lens element 1140 with positive refractive power has an object-side surface 1141 being convex in a paraxial region thereof and an image-side surface 1142 being convex in a paraxial region thereof. The fourth lens element 1140 is made of a plastic material, and has the object-side surface 1141 and the image-side surface 1142 being both aspheric.

The fifth lens element 1150 with negative refractive power has an object-side surface 1151 being concave in a paraxial region thereof and an image-side surface 1152 being concave in a paraxial region thereof. The fifth lens element 1150 is made of a plastic material, and has the object-side surface 1151 and the image-side surface 1152 being both aspheric.

The sixth lens element 1160 with positive refractive power has an object-side surface 1161 being convex in a paraxial region thereof and an image-side surface 1162 being convex in a paraxial region thereof. The sixth lens element 1160 is made of a plastic material, and has the object-side surface 1161 and the image-side surface 1162 being both aspheric.

The seventh lens element 1170 with positive refractive power has an object-side surface 1171 being convex in a paraxial region thereof and an image-side surface 1172 being concave in a paraxial region thereof. The seventh lens element 1170 is made of a plastic material, and has the object-side surface 1171 and the image-side surface 1172 being both aspheric. Furthermore, the object-side surface 1171 of the seventh lens element 1170 includes at least one concave shape in an off-axial region thereof, and the object-side surface 1171 and the image-side surface 1172 of the seventh lens element 1170 both include at least one inflection point.

The filter 1180 is made of a glass material and located between the seventh lens element 1170 and the image surface 1190, and will not affect the focal length of the optical imaging lens assembly.

The detailed optical data of the 11th embodiment are shown in TABLE 21 and the aspheric surface data are shown in TABLE 22 below.

TABLE 21
11th Embodiment
f = 2.68 mm, Fno = 2.80, HFOV = 75.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 10.201 | | 0.800 | Glass | 1.804 | 46.5 | −6.47 |
| 2 | | 3.324 | | 1.771 | | | | |
| 3 | Lens 2 | 3.491 | ASP | 0.781 | Plastic | 1.544 | 55.9 | −4.71 |
| 4 | | 1.361 | ASP | 1.181 | | | | |
| 5 | Lens 3 | 4.875 | | 3.700 | Glass | 1.805 | 25.5 | 4.71 |
| 6 | | −11.330 | | 0.097 | | | | |
| 7 | Ape. Stop | Plano | | 0.123 | | | | |
| 8 | Lens 4 | 12.370 | ASP | 1.178 | Plastic | 1.535 | 55.8 | 4.13 |
| 9 | | −2.601 | ASP | 0.089 | | | | |
| 10 | Lens 5 | −4.654 | ASP | 0.575 | Plastic | 1.639 | 23.5 | −3.08 |
| 11 | | 3.578 | ASP | 0.111 | | | | |
| 12 | Lens 6 | 5.872 | ASP | 1.157 | Plastic | 1.535 | 55.8 | 10.37 |
| 13 | | −94.250 | ASP | 0.802 | | | | |
| 14 | Lens 7 | 2.986 | ASP | 1.916 | Plastic | 1.535 | 55.8 | 5.96 |
| 15 | | 36.526 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.722 | | | | |
| 18 | Image | Plano | — | | | | |

Reference wavelength is 587.6 nm (d-line).

TABLE 22
Aspheric Coefficients

| | Surface # | | | | |
|---|---|---|---|---|---|
| | 3 | 4 | 8 | 9 | 10 |
| k = | −1.8609E+00 | −7.0566E−01 | −1.3508E+01 | −8.8377E−01 | −2.6606E+01 |
| A4 = | −1.4568E−02 | −2.8766E−02 | 1.9002E−03 | −2.4567E−02 | −9.2136E−02 |
| A6 = | 1.8670E−03 | 1.2031E−03 | 1.4676E−03 | 9.5883E−03 | 3.3414E−02 |
| A8 = | −1.6774E−04 | −1.0646E−04 | −4.1474E−03 | −9.1579E−03 | −1.5166E−02 |
| A10 = | 8.4841E−06 | −5.0980E−05 | | 3.9411E−04 | 1.7453E−03 |
| A12 = | −1.8276E−07 | | | | |
| | Surface # | | | | |
| | 11 | 12 | 13 | 14 | 15 |
| k = | −1.0731E+01 | −4.5165E+01 | 9.0000E+01 | −5.8165E+00 | 8.9972E+01 |
| A4 = | −2.1089E−03 | 2.2956E−02 | −3.7405E−02 | −1.2738E−03 | 7.0286E−04 |
| A6 = | −6.0583E−03 | −1.6627E−02 | 1.1702E−02 | −6.0258E−05 | −7.3226E−04 |
| A8 = | 4.1724E−03 | 6.5864E−03 | −2.8587E−03 | 3.2145E−05 | 7.8419E−05 |
| A10 = | −1.0571E−03 | −1.2278E−03 | 4.7417E−04 | −2.0138E−06 | −3.1801E−06 |
| A12 = | 9.1122E−05 | 8.5058E−05 | −3.1579E−05 | | |

In the 11th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 11th embodiment, so an explanation in this regard will not be provided again.

Moreover, these parameters can be calculated from TABLE 21 and TABLE 22 as the following values and satisfy the following conditions:

11th Embodiment

| | | | |
|---|---|---|---|
| f (mm) | 2.68 | (R5 + R6)/(R5 − R6) | −0.40 |
| Fno | 2.80 | (R7 + R8)/(R7 − R8) | 0.65 |
| HFOV (deg.) | 75.0 | (R9 + R10)/(R9 − R10) | 0.13 |
| \|1/tan(HFOV)\| | 0.27 | R2/R4 | 2.44 |
| V7 | 55.8 | \|R10/R11\| | 0.61 |
| (V3 + V7)/2 | 40.61 | f/T67 | 3.34 |
| CT2/CT3 | 0.21 | (\|f1\| + \|f2\| + \|f3\| + \|f4\| + \|f5\|)/ | 1.41 |
| | | (\|f6\| + \|f7\|) | |
| CT6/CT3 | 0.31 | SD/TD | 0.42 |
| (CT4 + CT5 + CT6)/CT3 | 0.79 | Yc71/f | — |
| ΣCT/CT3 | 2.73 | Yc72/f | 0.80 |
| T45/T56 | 0.80 | Y11/Y72 | 1.49 |

Furthermore, in the optical imaging lens assembly according to the 11th embodiment, when a focal length of the first lens element 1110 is f1, a focal length of the second lens element 1120 is f2, a focal length of the third lens element 1130 is f3, a focal length of the fourth lens element 1140 is f4, a focal length of the fifth lens element 1150 is f5, a focal length of the sixth lens element 1160 is f6, and a focal length of the seventh lens element 1170 is f7, a minimum value among absolute values of f1, f2, f3, f4, f5, f6, and f7 is the absolute value of f5.

### 12th Embodiment

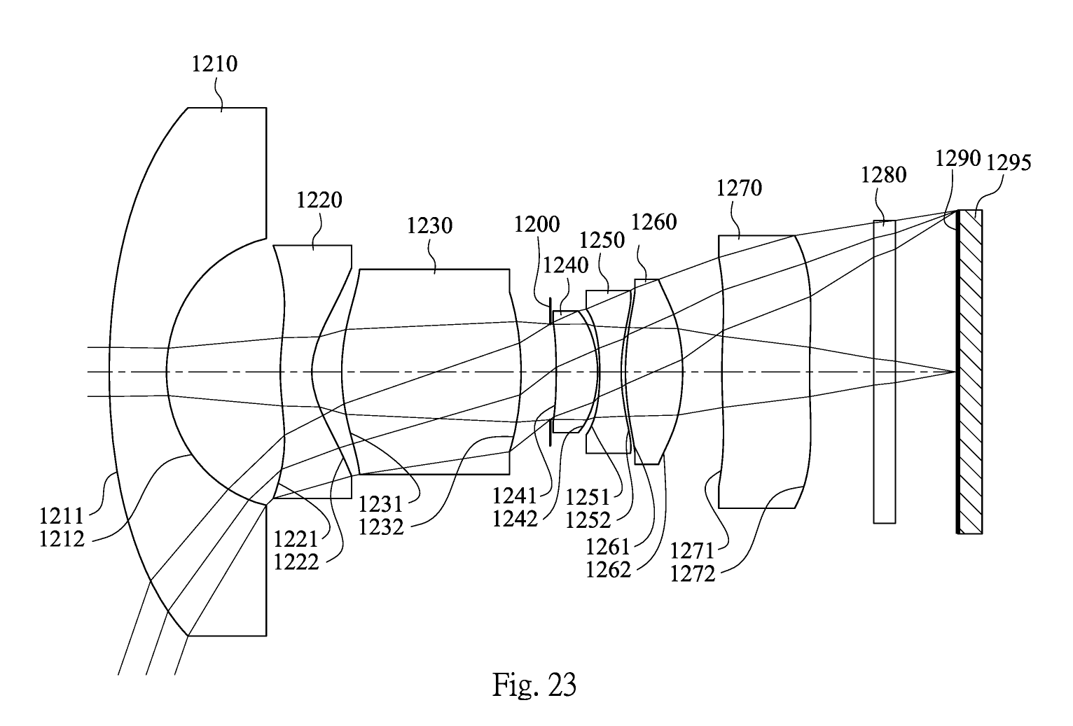

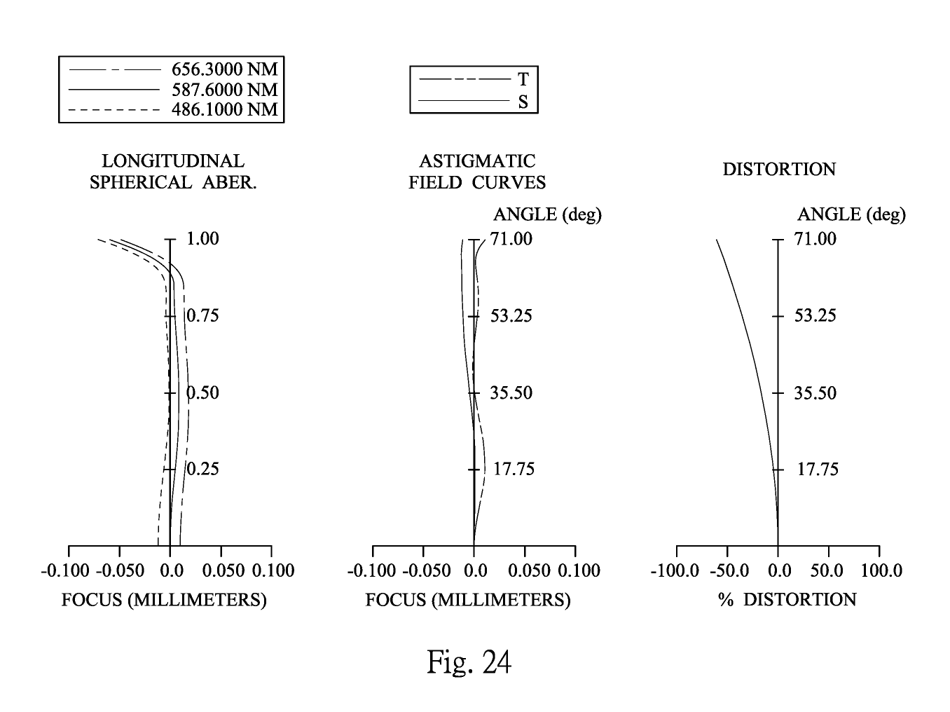

FIG. 23 is a schematic view of an image capturing apparatus according to the 12th embodiment of the present disclosure. FIG. 24 shows, in order from left to right, spherical aberration curves, astigmatic field curves and a distortion curve of the image capturing apparatus according to the 12th embodiment. In FIG. 23, the image capturing apparatus includes the optical imaging lens assembly (its reference numeral is omitted) and an image sensor 1295. The optical imaging lens assembly includes, in order from an object side to an image side, a first lens element 1210, a second lens element 1220, a third lens element 1230, an aperture stop 1200, a fourth lens element 1240, a fifth lens element 1250, a sixth lens element 1260, a seventh lens element 1270, a filter 1280 and an image surface 1290. The image sensor 1295 is disposed on the image surface 1290 of the optical imaging lens assembly. The optical imaging lens assembly has a total of seven lens elements (1210-1270), Moreover, there is an air gap between every two of the first lens element 1210, the second lens element 1220, the third lens element 1230, the fourth lens element 1240, the fifth lens element 1250, the sixth lens element 1260 and the seventh lens element 1270 that are adjacent to each other.

The first lens element 1210 with negative refractive power has an object-side surface 1211 being convex in a paraxial region thereof and an image-side surface 1212 being concave in a paraxial region thereof. The first lens element 1210 is made of a glass material, and has the object-side surface 1211 and the image-side surface 1212 being both aspheric,

The second lens element 1220 with negative refractive power has an object-side surface 1221 being convex in a paraxial region thereof and an image-side surface 1222 being concave in a paraxial region thereof. The second lens element 1220 is made of a plastic material, and has the object-side surface 1221 and the image-side surface 1222 being both aspheric.

The third lens element 1230 with positive refractive power has an object-side surface 1231 being convex in a paraxial region thereof and art image-side surface 1232 being convex in a paraxial region thereof. The third lens element 1230 is made of a glass material, and has the object-side surface 1231 and the image-side surface 1232 being both aspheric.

The fourth lens element 1240 with positive refractive power has an object-side surface 1241 being concave in a paraxial region thereof and an image-side surface 1242 being convex in a paraxial region thereof. The fourth lens element 1240 is made of a plastic material, and has the object-side surface 1241 and the image-side surface 1242 being both aspheric.

The fifth lens element 1250 with negative refractive power has an object-side surface 1251 being concave in a paraxial region thereof and an image-side surface 1252 being concave in a paraxial region thereof. The fifth lens element 1250 is made of a plastic material, and has the object-side surface 1251 and the image-side surface 1252 being both aspheric.

The sixth lens element 1260 with positive refractive power has an object-side surface 1261 being convex in a paraxial region thereof and an image-side surface 1262 being convex in a paraxial region thereof. The sixth lens element 1260 is made of a plastic material, and has the object-side surface 1261 and the image-side surface 1262 being both aspheric.

The seventh lens element 1270 with positive refractive power has an object-side surface 1271 being convex in a paraxial region thereof and an image-side surface 1272 being concave in a paraxial region thereof. The seventh lens element 1270 is made of a plastic material, and has the object-side surface 1271 and the image-side surface 1272 being both aspheric. Furthermore, the object-side surface 1271 of the seventh lens element 1270 includes at least one concave shape in an off-axial region thereof, and the object-side surface 1271 and the image-side surface 1272 of the seventh lens element 1270 both include at least one inflection point.

The filter 1280 is made of a glass material and located between the seventh lens element 1270 and the image surface 1290, and will not affect the focal length of the optical imaging lens assembly.

The detailed optical data of the 12th embodiment are shown in TABLE 23 and the aspheric surface data are shown in TABLE 24 below.

TABLE 23
12th Embodiment
f = 3.29 mm, Fno = 2.86, HFOV = 71.0 deg.

| Surface # | | Curvature Radius | | Thickness | Material | Index | Abbe # | Focal Length |
|---|---|---|---|---|---|---|---|---|
| 0 | Object | Plano | | Infinity | | | | |
| 1 | Lens 1 | 16.082 | ASP | 1.338 | Glass | 1.757 | 48.6 | −6.51 |
| 2 | | 3.637 | ASP | 2.657 | | | | |
| 3 | Lens 2 | 5.636 | ASP | 0.737 | Plastic | 1.544 | 55.9 | −5.11 |
| 4 | | 1.775 | ASP | 0.697 | | | | |
| 5 | Lens 3 | 4.858 | ASP | 4.189 | Glass | 1.890 | 36.0 | 3.86 |
| 6 | | −6.955 | ASP | 0.679 | | | | |
| 7 | Ape. Stop | Plano | | 0.142 | | | | |
| 8 | Lens 4 | −14.085 | ASP | 0.967 | Plastic | 1.535 | 55.8 | 6.41 |
| 9 | | −2.822 | ASP | 0.050 | | | | |
| 10 | Lens 5 | −6.354 | ASP | 0.500 | Plastic | 1.639 | 23.5 | −3.85 |
| 11 | | 4.135 | ASP | 0.100 | | | | |
| 12 | Lens 6 | 6.046 | ASP | 1.336 | Plastic | 1.535 | 55.8 | 5.46 |
| 13 | | −5.212 | ASP | 0.916 | | | | |
| 14 | Lens 7 | 13.024 | ASP | 2.049 | Plastic | 1.535 | 55.8 | 71.07 |
| 15 | | 18.724 | ASP | 1.500 | | | | |

| | | | | | | | |
|---|---|---|---|---|---|---|---|
| 16 | Filter | Plano | 0.500 | Glass | 1.517 | 64.2 | — |
| 17 | | Plano | 1.466 | | | | |
| 18 | Image | Plano | — | | | | |

Reference wavelength is 587.6 nm (d-line).

TABLE 24
Aspheric Coefficients

| Surface # | 1 | 2 | 3 | 4 | 5 | 6 | 8 |
|---|---|---|---|---|---|---|---|
| k = | 4.5701E+00 | 3.0888E−01 | −9.9262E+00 | −7.8263E−01 | −9.5985E−01 | 8.0504E+00 | 3.8918E+01 |
| A4 = | 3.8473E−04 | 1.4896E−03 | −1.9188E−02 | −3.7950E−02 | −1.1241E−03 | 1.8170E−03 | −8.6216E−03 |
| A6 = | −1.6624E−05 | −8.3756E−06 | 1.8164E−03 | 3.2685E−03 | −3.5704E−04 | 4.5836E−04 | 8.6829E−05 |
| A8 = | 3.9088E−07 | −1.5143E−07 | −1.2002E−04 | −4.2956E−04 | −1.3738E−04 | −9.3370E−05 | −4.7659E−04 |
| A10 = | −3.5686E−09 | −3.4918E−07 | 6.4216E−06 | 3.0616E−05 | 1.2731E−05 | 3.4100E−05 | −6.5897E−04 |
| A12 = | | | −1.8276E−07 | | | | |
| Surface # | 9 | 10 | 11 | 12 | 13 | 14 | 15 |
| k = | −4.1921E−01 | −4.1838E+01 | −9.5566E+00 | −4.3084E+01 | −2.5437E+01 | −6.0154E+01 | −8.9988E+01 |
| A4 = | −1.2361E−02 | −4.5775E−02 | 2.9071E−03 | 2.1413E−02 | −3.4514E−02 | −8.5965E−03 | −5.6854E−03 |
| A6 = | 3.4534E−03 | 1.2003E−02 | −7.4037E−03 | −1.5177E−02 | 9.3556E−03 | 6.8343E−04 | 8.1060E−05 |
| A8 = | −2.7043E−03 | −4.8742E−03 | 3.7630E−03 | 6.2815E−03 | −2.6222E−03 | −5.5317E−05 | −9.0772E−06 |
| A10 = | −4.9249E−04 | 6.7153E−05 | −9.4361E−04 | −1.2781E−03 | 4.8798E−04 | 3.8045E−06 | 5.3900E−07 |
| A12 = | | | 6.2601E−05 | 8.5058E−05 | −3.1579E−05 | | |

In the 12th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 12th embodiment, so an explanation in this regard will not be provided again.

Moreover, these parameters can be calculated from TABLE 23 and TABLE 24 as the following values and satisfy the following conditions:

12th Embodiment

| | | | |
|---|---|---|---|
| f (mm) | 3.29 | (R5 + R6)/(R5 − R6) | −0.18 |
| Fno | 2.86 | (R7 + R8)/(R7 − R8) | 1.50 |
| HFOV (deg.) | 71.0 | (R9 + R10)/(R9 − R10) | 0.21 |
| \|1/tan(HFOV)\| | 0.34 | R2/R4 | 2.05 |
| V7 | 55.8 | \|R10/R11\| | 0.68 |
| (V3 + V7)/2 | 45.89 | f/T67 | 3.59 |
| CT2/CT3 | 0.18 | (\|f1\| + \|f2\| + \|f3\| + \|f4\| + \|f5\|)/ | 0.34 |
| | | (\|f6\| + \|f7\|) | |
| CT6/CT3 | 0.32 | SD/TD | 0.37 |
| (CT4 + CT5 + CT6)/CT3 | 0.67 | Yc71/f | 0.44 |
| ΣCT/CT3 | 2.65 | Yc72/f | 0.43 |
| T45/T56 | 0.50 | Y11/Y72 | 1.94 |

Furthermore, in the optical imaging lens assembly according to the 12th embodiment, when a focal length of the first lens element 1210 is f1, a focal length of the second lens element 1220 is f2, a focal length of the third lens element 1230 is f3, a focal length of the fourth lens element 1240 is f4, a focal length of the fifth lens element 1250 is f5, a focal length of the sixth lens element 1260 is f6, and a focal length of the seventh lens element 1270 is f7, a minimum value among absolute values of f1, f2, f3, f4, f5, f6, and f7 is the absolute value of f5.

### 13th Embodiment

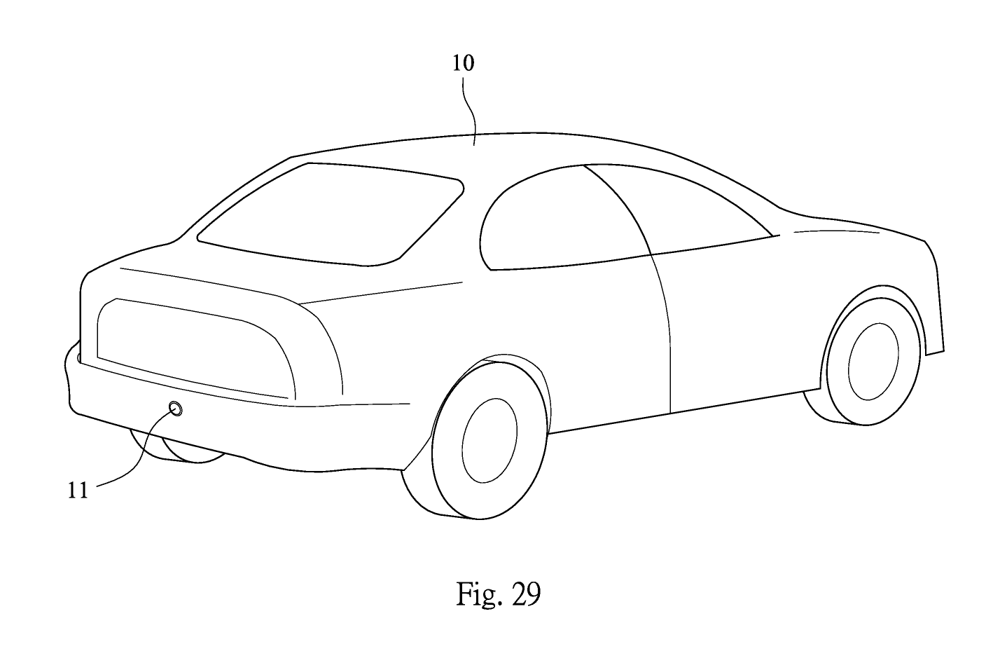

FIG. 29 shows an electronic device 10 according to the 13th embodiment of the present disclosure. The electronic device 10 of the 13th embodiment is a rear view camera system, wherein the electronic device 10 includes an image capturing apparatus 11. The image capturing apparatus 11 includes an optical imaging lens assembly (not shown herein) according to the present disclosure and an image sensor (not shown herein), wherein the image sensor is disposed on an image surface of the optical imaging lens assembly.

### 14th Embodiment

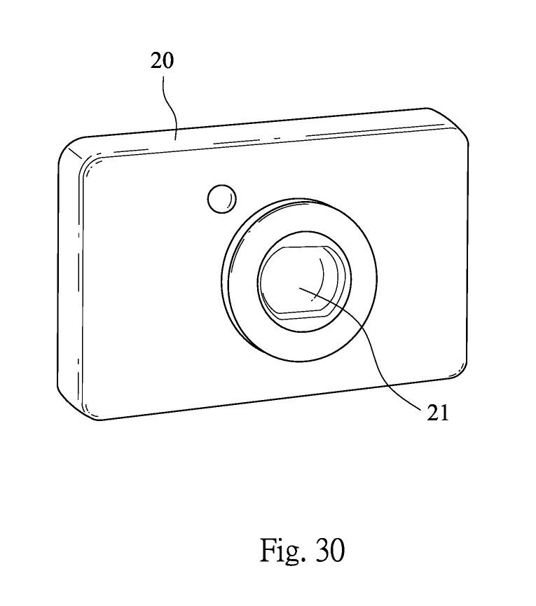

FIG. 30 shows an electronic device 20 according to the 14th embodiment of the present disclosure. The electronic device 20 of the 14th embodiment is a driving recorder, wherein the electronic device 20 includes an image capturing apparatus 21. The image capturing apparatus 21 includes an optical imaging lens assembly (not shown herein) according to the present disclosure and an image sensor (not shown herein), wherein the image sensor is disposed on an image surface of the optical imaging lens assembly.

### 15th Embodiment

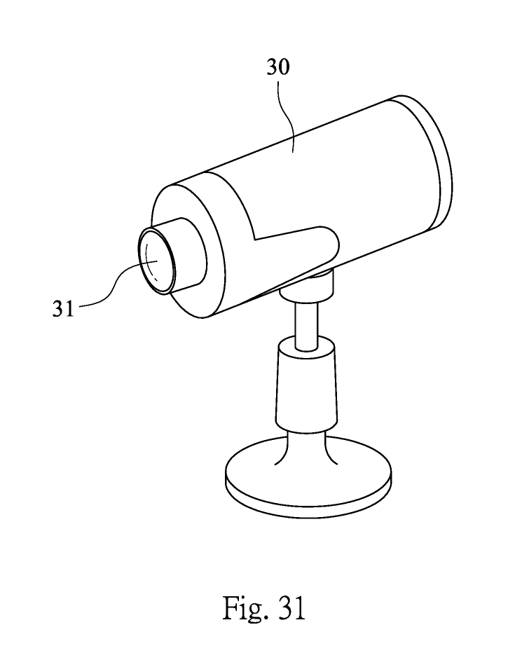

FIG. 31 shows an electronic device 30 according to the 15th embodiment of the present disclosure. The electronic device 30 of the 15th embodiment is a surveillance device, wherein the electronic device 30 includes an image capturing apparatus 31. The image capturing apparatus 31 includes an optical imaging lens assembly (not shown herein) according to the present disclosure and an image sensor (not shown herein), wherein the image sensor is disposed on an image surface of the optical imaging lens assembly.

The foregoing description, for purpose of explanation, has been described with reference to specific embodiments. It is to be noted that TABLES 1-24 show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical imaging lens assembly comprising, in order from an object side to an image side:
a first lens element having negative refractive power;
a second lens element having negative refractive power;
a third lens element having positive refractive power;
a fourth lens element having positive refractive power;
a fifth lens element having negative refractive power;
a sixth lens element; and
a seventh lens element having an object-side surface and an image-side surface being both aspheric, wherein at least one of the object-side surface and the image-side surface of the seventh lens element comprises at least one inflection point;
wherein the optical imaging lens assembly has a total of seven lens elements, a focal length of the optical imaging lens assembly is f, an axial distance between the sixth lens element and the seventh lens element is T67, a central thickness of the third lens element is CT3, a central thickness of the sixth lens element is CT6, and the following conditions are satisfied:
0<f/T67<9.0; and
0.05<CT6/CT3<0.85.

2. The optical imaging lens assembly of claim 1, wherein the second lens element has an object-side surface being convex in a paraxial region thereof and an image-side surface being concave in a paraxial region thereof.

3. The optical imaging lens assembly of claim 1, wherein the image-side surface of the seventh lens element is concave in a paraxial region thereof.

4. The optical imaging lens assembly of claim 1, wherein the fifth lens element has an image-side surface being concave in a paraxial region thereof, a curvature radius of an image-side surface of the first lens element is R2, a curvature radius of an image-side surface of the second lens element is R4, and the following condition is satisfied:
1.65<R2/R4<5.0.

5. The optical imaging lens assembly of claim 1, wherein the central thickness of the third lens element is CT3, a central thickness of the fourth lens element is CT4, a central thickness of the fifth lens element is CT5, the central thickness of the sixth lens element is CT6, and the following condition is satisfied:
0.20<(CT4+CT5+CT6)/CT3<1.50.

6. The optical imaging lens assembly of claim 1, wherein the central thickness of the third lens element is CT3, a sum of central thicknesses of the first lens element, the second lens element, the third lens element, the fourth lens element, the fifth lens element, the sixth lens element and the seventh lens element is ΣCT, and the following condition is satisfied:
1.50<ΣCT/CT3<3.50.

7. The optical imaging lens assembly of claim 1, wherein the central thickness of the third lens element is CT3, the central thickness of the sixth lens element is CT6, and the following condition is satisfied:
0.05<CT6/CT3<0.55.

8. The optical imaging lens assembly of claim 1, wherein a focal length of the first lens element is f1, a focal length of the second lens element is f2, a focal length of the third lens element is f3, a focal length of the fourth lens element is f4, a focal length of the fifth lens element is f5, a focal length of the sixth lens element is f6, a focal length of the seventh lens element is f7, and a minimum value among absolute values of f1, f2, f3, f4, f5, f6, and f7 is the absolute value of f5.

9. The optical imaging lens assembly of claim 1, wherein a curvature radius of an object-side surface of the fifth lens element is R9, a curvature radius of an image-side surface of the fifth lens element is R10, and the following condition is satisfied:
−2.40<(R9+R10)/(R9−R10)<2.40.

10. The optical imaging lens assembly of claim 1, wherein a curvature radius of an image-side surface of the fifth lens element is R10, a curvature radius of an object-side surface of the sixth lens element is R11, and the following condition is satisfied:

|r10/R11|<0.85.

11. The optical imaging lens assembly of claim 1, wherein a focal length of the first lens element is f1, a focal length of the second lens element is f2, a focal length of the third lens element is f3, a focal length of the fourth lens element is f4, a focal length of the fifth lens element is f5, a focal length of the sixth lens element is f6, a focal length of the seventh lens element is f7, and the following condition is satisfied:
(|f1|+|f2|+|f3|+|f4|+|f5|)/(|f6|+|f7|)<1.65.

12. The optical imaging lens assembly of claim 1, further comprising:
an aperture stop, wherein an axial distance between the aperture stop and the image-side surface of the seventh lens element is SD, an axial distance between an object-side surface of the first lens element and the image-side surface of the seventh lens element is TD, a vertical distance between at least one critical point in an off-axial region on the object-side surface or the image-side surface of the seventh lens element and an optical axis is Yc7x, the focal length of the optical imaging lens assembly is f, and the following conditions are satisfied:
0.10<SD/TD<0.52; and
0.10<Yc7x/f<2.0.

13. The optical imaging lens assembly of claim 1, wherein a vertical distance between a maximum effective radius position of an object-side surface of the first lens element and an optical axis is Y11, a vertical distance between a maximum effective radius position of the image-side surface of the seventh lens element and the optical axis is Y72, and the following condition is satisfied:
1.0<Y11/Y72<1.75.

14. The optical imaging lens assembly of claim 1, wherein an Abbe number of the third lens element is V3, an Abbe number of the seventh lens element is V7, and the following condition is satisfied:
(V3+V7)/2<45.0.

15. The optical imaging lens assembly of claim 1, wherein the object-side surface of the seventh lens element is convex in a paraxial region thereof, and the object-side surface of the seventh lens element comprises at least one concave shape in an off-axial region thereof.

16. The optical imaging lens assembly of claim 1, wherein there is an air gap between every two of the first lens element, the second lens element, the third lens element, the fourth lens element, the fifth lens element, the sixth lens element and the seventh lens element that are adjacent to each other, a half of a maximum field of view of the optical imaging lens assembly is HFOV, and the following condition is satisfied:

|1/tan(HFOV)|<0.85.

17. An image capturing apparatus, comprising:
the optical imaging lens assembly of claim 1; and
an image sensor, wherein the image sensor is disposed on an image surface of the optical imaging lens assembly.

18. An electronic device, comprising:
the image capturing apparatus of claim 17.

19. An optical imaging lens assembly comprising, in order from an object side to an image side:
a first lens element having negative refractive power;
a second lens element having negative refractive power;
a third lens element having positive refractive power;
a fourth lens element having positive refractive power;
a fifth lens element with negative refractive power having an image-side surface being concave in a paraxial region thereof;
a sixth lens element; and
a seventh lens element having an object-side surface and an image-side surface being both aspheric, wherein at least one of the object-side surface and the image-side surface of the seventh lens element comprises at least one inflection point;
wherein the optical imaging lens assembly has a total of seven lens elements, a focal length of the optical imaging lens assembly is f, an axial distance between the sixth lens element and the seventh lens element is T67, a curvature radius of an object-side surface of the fifth lens element is R9, a curvature radius of the image-side surface of the fifth lens element is R10, and the following conditions are satisfied:
0<f/T67<9.0; and
−0.20<(R9+R10)/(R9−R10)<2.40.

20. The optical imaging lens assembly of claim 19, wherein the object-side surface of the seventh lens element is convex in a paraxial region thereof.

21. The optical imaging lens assembly of claim 19, wherein the image-side surface of the seventh lens element is concave in a paraxial region thereof.

22. The optical imaging lens assembly of claim 19, wherein a vertical distance between at least one critical point in an off-axial region on the object-side surface or the image-side surface of the seventh lens element and an optical axis is Yc7x, the focal length of the optical imaging lens assembly is f, and the following condition is satisfied:
0.10<Yc7x/f<2.0.

23. The optical imaging lens assembly of claim 19, wherein the focal length of the optical imaging lens assembly is f, the axial distance between the sixth lens element and the seventh lens element is T67, and the following condition is satisfied:
0<f/T67<5.0.

24. The optical imaging lens assembly of claim 19, wherein a central thickness of the third lens element is CT3, a sum of central thicknesses of the first lens element, the second lens element, the third lens element, the fourth lens element, the fifth lens element, the sixth lens element and the seventh lens element is ΣCT, and the following condition is satisfied:
1.50<ΣCT/CT3<3.50.

25. The optical imaging lens assembly of claim 19, wherein a central thickness of the second lens element is CT2, a central thickness of the third lens element is CT3, and the following condition is satisfied:
0<CT2/CT3<0.30.

26. The optical imaging lens assembly of claim 19, wherein a curvature radius of an object-side surface of the third lens element is R5, a curvature radius of an image-side surface of the third lens element is R6, and the following condition is satisfied:
−2.80<(R5+R6)/(R5−R6)<0.65.

27. The optical imaging lens assembly of claim 19, wherein an axial distance between the fourth lens element and the fifth fens element is T45, an axial distance between the fifth lens element and the sixth lens element is T56, and the following condition is satisfied:
0.15<T45/T56<3.0.

28. The optical imaging lens assembly of claim 19, wherein a focal length of the first lens element is f1, a focal length of the second lens element is f2, a focal length of the third lens element is f3, a focal length of the fourth lens element is f4, a focal length of the fifth lens element is f5, a focal length of the sixth lens element is f6, a focal length of the seventh lens element is f7, and the following condition is satisfied:
(|f1|+|f2|+|f3|+|f4|+|f5|)/(|f6|+|f7|)<1.65.

29. The optical imaging lens assembly of claim 19, further comprising:
an aperture stop, wherein an axial distance between the aperture stop and the image-side surface of the seventh lens element is SD, an axial distance between an object-side surface of the first lens element and the image-side surface of the seventh lens element is TD, and the following condition is satisfied:
0.10<SD/TD<0.52.

30. The optical imaging lens assembly of claim 19, wherein a curvature radius of an image-side surface of the first lens element is R2, a curvature radius of an image-side surface of the second lens element is R4, and the following condition is satisfied:
1.65<R2/R4<5.0.

31. The optical imaging lens assembly of claim 19, wherein an Abbe number of the seventh lens element is V7, and the following condition is satisfied:
V7<40.0.

32. The optical imaging lens assembly of claim 19, wherein a curvature radius of an object-side surface of the fourth lens element is R7, a curvature radius of an image-side surface of the fourth lens element is R8, and the following condition is satisfied:
−0.85<(R7+R8)/(R7−R8)<0.85.
